(19) United States
(12) Patent Application Publication
(10) Pub. No.: US 2015/0019600 A1
(43) Pub. Date: Jan. 15, 2015

(54) COMPUTER PRODUCT, FILE IDENTIFYING APPARATUS, AND FILE EVALUATION METHOD

(71) Applicant: FUJITSU LIMITED, Kawasaki-shi (JP)

(72) Inventors: Ryu KANEHIRA, Kawasaki (JP); Kuniaki SHIMADA, Kawasaki (JP); Yuji WADA, Ota (JP)

(73) Assignee: FUJITSU LIMITED, Kawasaki-shi (JP)

(21) Appl. No.: 14/319,104

(22) Filed: Jun. 30, 2014

(30) Foreign Application Priority Data
Jul. 9, 2013 (JP) 2013-143300

(51) Int. Cl. G06F 17/30

(52) U.S. Cl. CPC G06F 17/30106; G06F 17/30203
USPC 707/827

(57) ABSTRACT

A non-transitory, computer-readable recording medium stores a file evaluation program that causes a computer to execute a process including classifying, for each server group of a plurality of server groups, a plurality of files of a same name into a layer that is one of a plurality of layers, based on a matching degree of contents of the plurality of files, the plurality of files being stored in the server group; and extracting a first plurality of files having a same name, being classified into different layers, and being stored in different server groups among the plurality of server groups.

### CROSS REFERENCE TO RELATED APPLICATIONS

This application is based upon and claims the benefit of priority of the prior Japanese Patent Application No. 2013-143300, filed on Jul. 9, 2013, the entire contents of which are incorporated herein by reference.

### FIELD

The embodiments discussed herein are related to a computer product, a file identifying apparatus, and a file evaluation method.

### BACKGROUND

According to a conventional technique, whether the content of a file is normal is determined based on a result of a comparison made between the contents of two files. For example, according to another related technique, a comparison is made between file data whose originality is guaranteed and file data that is to be checked and released on an application operating server. According to another technique, a modification tag describing the modified portions of an application is read from an execution result trace of the application, and the modified portions are excluded from being subject to a comparison made between an existing system and a new system. According to yet another technique, a managing server makes a comparison between the hardware configurations of a deployment source server apparatus and a deployment destination server apparatus in response to a deployment instruction from a user, and changes the deployment method according to the difference obtained from the comparison (see, e.g., Japanese Laid-Open Patent Publication Nos. 2012-053635, 2012-203580, and 2009-122963).

Nonetheless, according to the conventional techniques, it is difficult to identify a file whose content is corrupt among files included in a server group when a problem occurs in a service provided by the server group. For example, in a case where the servers of the server group compare the contents of their files with each other, even when the contents of the files differ among the servers, the files may include both a file whose content is different from the others because of corrupt content, and a file whose content is different because it is normal for the content of each server to differ from each other. Therefore, it is difficult to precisely identify a file whose content is highly likely to be corrupt based only on the result of the comparison of the file contents.

### SUMMARY

According to an aspect of an embodiment, a non-transitory, computer-readable recording medium stores a file evaluation program that causes a computer to execute a process including classifying, for each server group of a plurality of server groups, a plurality of files of a same name into a layer that is one of a plurality of layers, based on a matching degree of contents of the plurality of files, the plurality of files being stored in the server group; and extracting a first plurality of files having a same name, being classified into different layers, and being stored in different server groups among the plurality of server groups.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of operation of a file identifying apparatus according to an embodiment;

FIG. 2 is an explanatory diagram of an example of a cloud system to be evaluated;

FIG. 3 is a block diagram of a hardware configuration of the file identifying apparatus;

FIG. 4 is a block diagram of an example of a functional configuration of the file identifying apparatus;

FIG. 5 is an explanatory diagram of an example of the contents of a file set table;

FIGS. 6, 7, 8, and 9 are explanatory diagrams (Parts I, II, III, and IV) of an example of generation of the file set table;

FIG. 10 is an explanatory diagram of an example of extraction of files for which a common server count differs from each other;

FIG. 11 is an explanatory diagram of an example of a risk for a file whose common server counts differ;

FIG. 12 is an explanatory diagram of the relation between configuration information and the common server count;

FIG. 13 is an explanatory diagram of the relation between risk and deviation degree;

FIGS. 14A, 14B, and 14C are explanatory diagrams of the deviation degree for a given file;

FIGS. 15A and 15B are explanatory diagrams of the deviation degree for given files to be compared between environments;

FIG. 16 is an explanatory diagram of a first example of a deviation function;

FIG. 17 is an explanatory diagram of a second example of the deviation function;

FIGS. 18 and 19 are explanatory diagrams (Parts I and II) of an example of calculation of the value of the deviation degree based on the deviation function;

FIG. 20 is an explanatory diagram of environments A and B, and the configuration information thereof used in a specific example;

FIG. 21 is an explanatory diagram of files included in environments A and B used in the specific example;

FIG. 22 is an explanatory diagram of a specific example of a generation of the file set table;

FIG. 23 is an explanatory diagram of a specific example of files whose common server counts differ;

FIG. 24 is an explanatory diagram of a specific example of a generation of the layers;

FIG. 25 is an explanatory diagram of a specific example of a calculation of the degree of risk;

FIG. 26 is an explanatory diagram of the adequacy of the degree of risk;

FIG. 27 is an explanatory diagram of an example of display of the degree of risk;

FIG. 28 is a flowchart of an example of a procedure for a file evaluation process;

FIG. 29 is a flowchart of an example of a procedure for the file set table generation process;

FIG. 30 is a flowchart of an example of a procedure for the set difference file identifying process; and

FIGS. 31, 32, and 33 are flowcharts (Parts I, II and III) of an example of a procedure for the degree of risk calculation process.

### DESCRIPTION OF EMBODIMENTS

Embodiments of a computer product, a file identifying apparatus, and a file evaluation method will be described in detail with reference to the accompanying drawings.

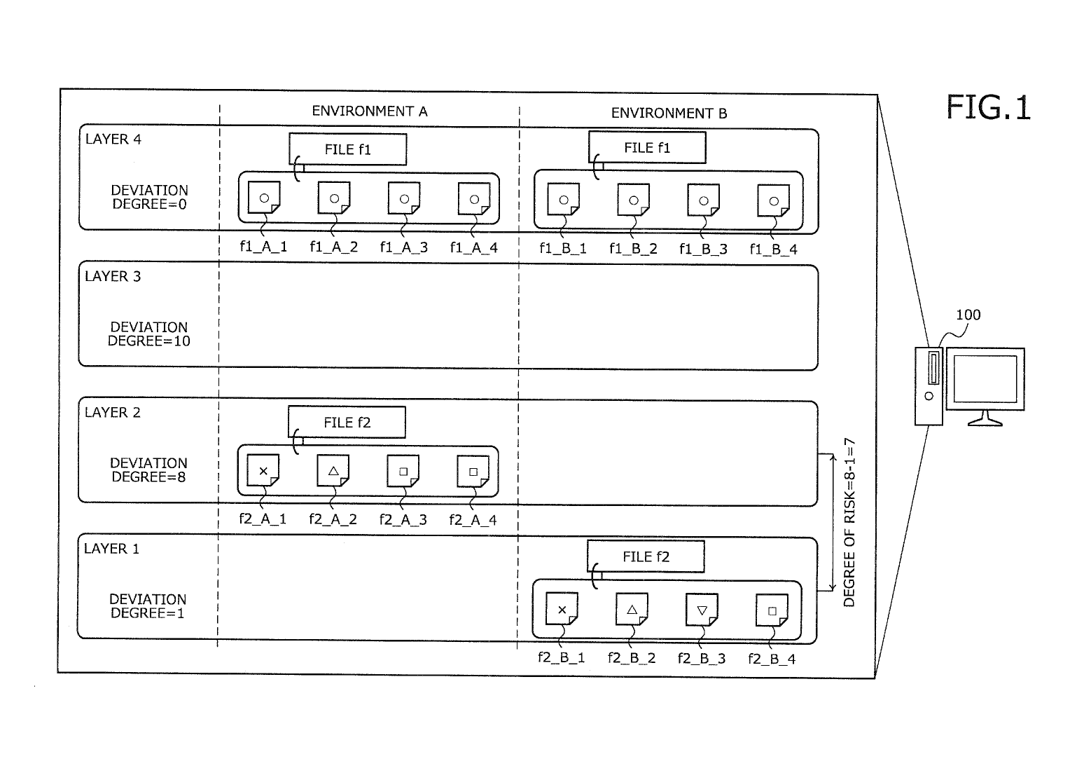

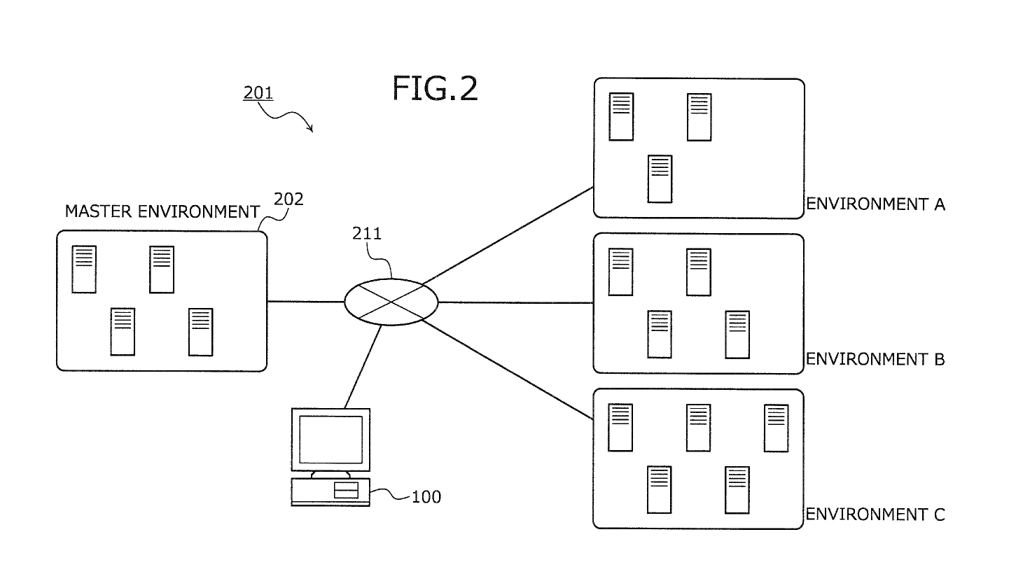

FIG. 1 is an explanatory diagram of an example of operation of a file identifying apparatus according to an embodiment. The file identifying apparatus 100 is a computer that identifies a corrupt file in an environment that includes server groups. A server group is a group of apparatuses providing cloud services or a group of apparatuses used to develop the cloud services. The relation between the server group and the cloud services will be described later with reference to FIG. 2.

When a problem occurs in an environment, a problem may be present in the contents of a file included in a server of a server group included in the environment. The contents of the file can be contents in which data is recorded such as setting values for the hardware included in the server, and setting values for software such as the operating system (OS) and application software executed by the server.

The cause of the problem in the contents of the file can be, for example, a case where a development engineer temporarily rewrites the contents of a file on a server for verification and thereafter, the development engineer forgets to return the rewritten contents to the original contents. In this case, no development engineer other than the development engineer who rewrote the contents of the file knows which file has been changed and therefore, it is difficult to identify the cause of the problem.

When the cause of the problem is identified, the manager operating the cloud service or the development engineer developing the cloud service views the contents of the files in the environment and checks whether errors are present. As a first example of a checking method, one method is present according to which the servers in the server group included in the environment having the problem compare with each other the contents of the files having the same name and thereby, check the contents of a file having contents that are different from the others. As a second example of a checking method, another method is present according to which a comparison is made between the contents of files having the same name by a server included in an environment having a problem and a server included in an environment whose configuration is similar to that of the environment having the problem; and thereby, the contents of a file having contents that are different from other files are checked.

However, whether the contents of the file are normal cannot be determined by the first or the second example though a file whose contents are different from the contents of other files can be identified. For example, in the first example, it is difficult to determine whether the difference in the file contents between the servers is the contents of the normal setting, or a mistake in the setting causes the difference in the file contents between the servers. In the second example; it is difficult to determine whether the difference in the file contents between the environments is the contents of the normal setting, or a mistake in the setting causes the difference in the file contents between the environments.

The file identifying apparatus 100 classifies into layers, files that are in file groups of the environments and have the same path, based on the matching degree of the contents of the files having the same name in the environments; obtains the difference in the deviation degrees corresponding to the layer of the two environments of the given file; and thereby, can identify a file having deviated contents. Presentation of the information concerning the file having the deviated contents to a user enables the user to first view the contents of the file whose contents are deviated and consequently, to precisely identify the file having corrupt contents.

FIG. 1 depicts files f1 and f2 as a file group of a server group that includes a first server having environment A and a second server having environment B. Environments A and B provide higher precision in identifying a file that has corrupt contents, when the configurations of environments A and B more resemble each other. For example, environments A and B each include four servers. Each of the servers includes files f1 and f2.

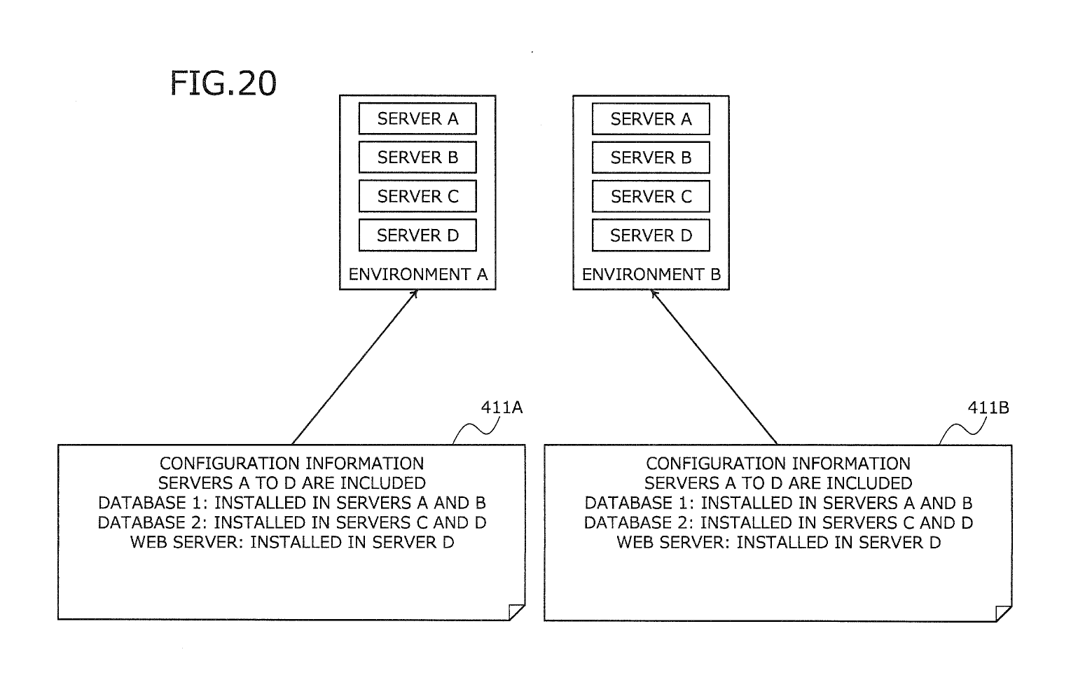

Whether the configurations of environments A and B resemble each other is equivalent to whether configuration information identifying the numbers of servers included in the environments resemble each other. The “configuration information” in this embodiment is configuration information concerning one environment and is, for example, information concerning the hardware included in the environment and/or information concerning the software installed in the server included in the environment. For example, it is assumed that an environment includes servers A, B, C, and D. In this case, the configuration information of the environment is information specifying that the environment includes the servers A to D; predetermined software is installed in each of the servers A and B; and an expansion disk is attached to the server D as predetermined hardware. An example of determining whether configuration information resembles each other will be described later with reference to FIG. 20.

In FIG. 1, for clarification of the description, a reference numeral is given to each of the files to enable determination as to which file in which environment a file is. At the head of a reference numeral given to a file, a character string obtained by dividing the reference numeral by underscores indicates whether the file to which the reference numeral is given is the file f1 or f2. Files having the same character string at the head of the reference numeral have the same name. A second character string obtained by dividing the reference numeral by underscores indicates whether the file to which the reference numeral is given is in environment A or B. The third character string obtained by dividing the reference numeral by underscores indicates at which position from the first server in the environment, the server including the file to which the reference numeral is given is.

For example, “file f1_A_{—}1” represents the file f1 included in the first server in environment A. Files f1_A_{—}1 to f1_A_{—}4 and files f1_B_{—}1 to f1_B_{—}4 are the files that have the same name. The configurations of environments A and B resemble each other and therefore, files of the same name are highly likely to be present in environments A and B.

In FIG. 1, the contents of each file is mocked by a character written in the file. Hereinafter, it is assumed that the character written in the file is simply the contents of the file. For example, the contents of both the files f1_A_{—}1 and f1_A_{—}2 are each “O” and are identical to each other.

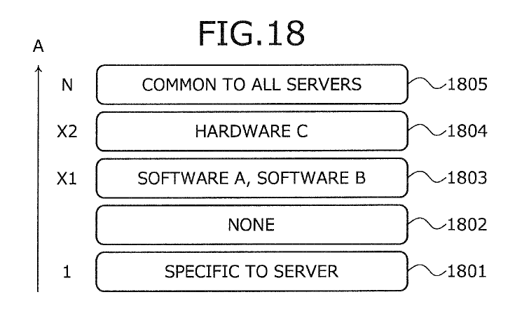

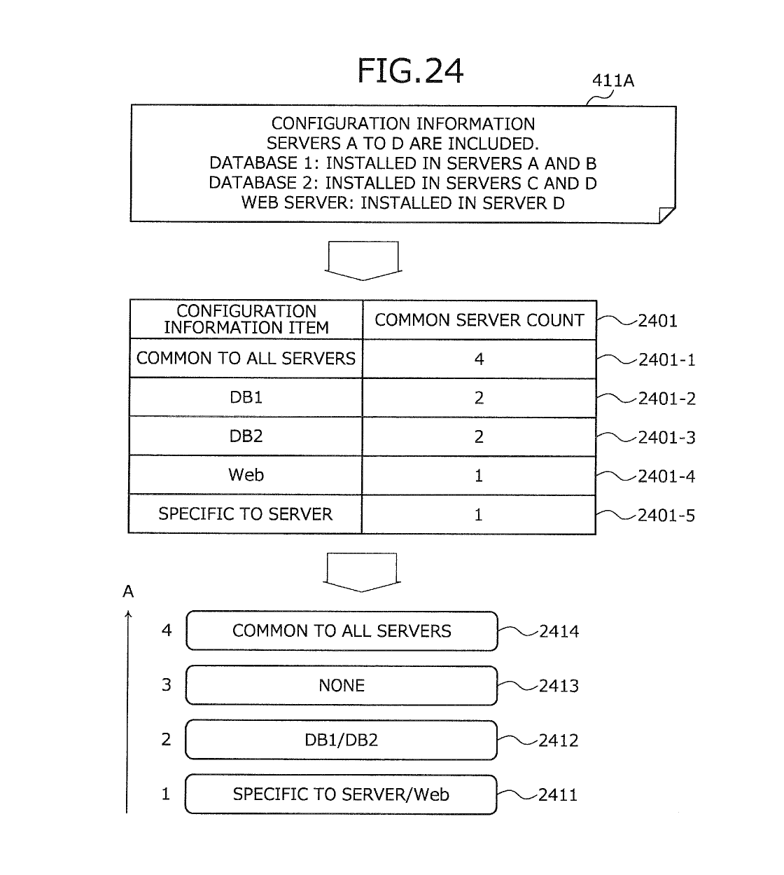

The file identifying apparatus 100 classifies files of the same name in a file group of a server group included in environment A into any one of plural layers, based on the matching degree of the contents of the files of the same name in the environments. The layers are created based on the configuration information. The matching degree of the contents of the files of the same name in the environment is the degree of matching among the contents of the files in each environment and is, for example, the number of servers that among the files having the same name, have files that have the same contents. The degree of matching of the contents of the files in the environment may be the number of servers that among the files having the same name, have files of the same contents except for the number of spaces; or may be the number of servers that have files of the same contents except for differences in linefeed code. An example of creating the plural layers will be described later with reference to FIGS. 18, 24, etc. It is assumed in the example depicted in FIG. 1 that layers 1 to 4 are created as the plural layers, which are of a number equivalent to the number of servers included in the environment. The number of servers that among the files that have the same name, have files of the same contents may hereinafter be referred to as “common server count”.

The contents of the files f1 in environment A are all “O” and the number of servers that have files of the same contents is four. Therefore, the file identifying apparatus 100 classifies the files f1 in environment A into layer 4. The contents of the files f2 in environment A are “x”, “Δ”, “ ”, and “ ” and the common server count is two. Therefore, the file identifying apparatus 100 classifies the files f2 in environment A into layer 2.

The contents of the files f1 in environment B are all “O” and the number of servers that have files of the same contents is four. Therefore, the file identifying apparatus 100 classifies the files f1 in environment B into layer 4. The contents of the files f2 in environment B are “x”, “Δ”, “∇”, and “ ” and the number of common servers is one. Therefore, the file identifying apparatus 100 classifies the files f2 in environment B into layer 1.

The file identifying apparatus 100 extracts the files that have the same name and have been classified into different layers. It is assumed, for example, that the file identifying apparatus 100 designates the file f1_A_{—}1 as a given file to be evaluated. The file identifying apparatus 100 determines whether the first layer into which the given file has been classified in environment A, and the second layer into which the file having the same name as that of the given file and included in any one of the servers in environment B has been classified in environment B, differ from one another. If the file identifying apparatus 100 determines that the first and the second layers differ, the file identifying apparatus 100 extracts the files as files having the same name and classified into different layers. The first layer into which the file f1_A_{—}1 is classified is layer 4, and the second layer into which the file f1_B_{—}1 having the same name as that of the file f1_A_{—}1 is classified, is layer 4. Therefore, the first and the second layers are same as one another.

It is assumed that the file identifying apparatus 100 designates the file f2_A_{—}1 as the given file to be evaluated. The file identifying apparatus 100 determines whether the first layer into which the given file has been classified, and the second layer into which the file included in any one of the servers in environment B and having the same name as that of the given file has been classified, differ from one another. The first layer into which the file f2_A_{—}1 is classified is layer 2 and the second layer into which the file f2_B_{—}1 having the same name of that of the file f2_A_{—}1 is classified, is layer 1 and therefore, the first and the second layers differ from one another. Therefore, the file identifying apparatus 100 extracts the file f2_A_{—}1 as files having the same name and classified into different layers.

After extracting the files having the same name and classified into the different layers, the file identifying apparatus 100, based on the first and the second layers, refers to the deviation degree of each layer and determines the degree of risk of the given file. The deviation degree is an index value that indicates the degree of deviation of the contents between the files having the same name and classified into plural layers among the layers.

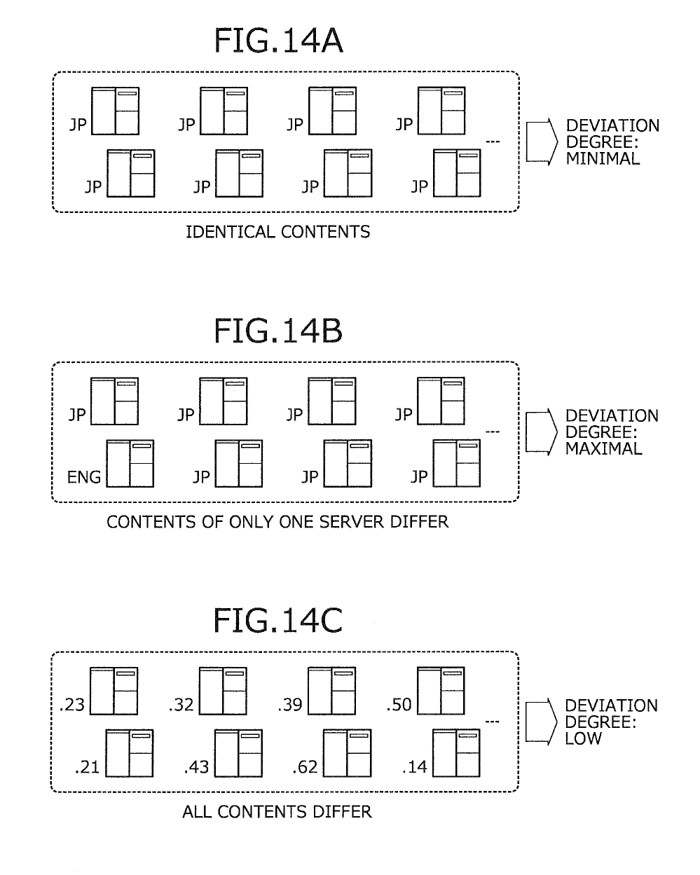

In the example depicted in FIG. 1, the deviation degree of layer 1 is “one”, that of layer 2 is “eight”, that of layer 3 is “10”, and that of layer 4 is “zero”. As indicated by the deviation degrees of the layers, the deviation degree is small in layer 4 in which all the files have the same contents and layer 1 in which all the files have different contents from each other; and the deviation degree is great in layer 2 in which only two files have contents identical to each other and layer 3 in which only one file has contents that differ from the others. The details of the deviation degree will be described later with reference to FIG. 14.

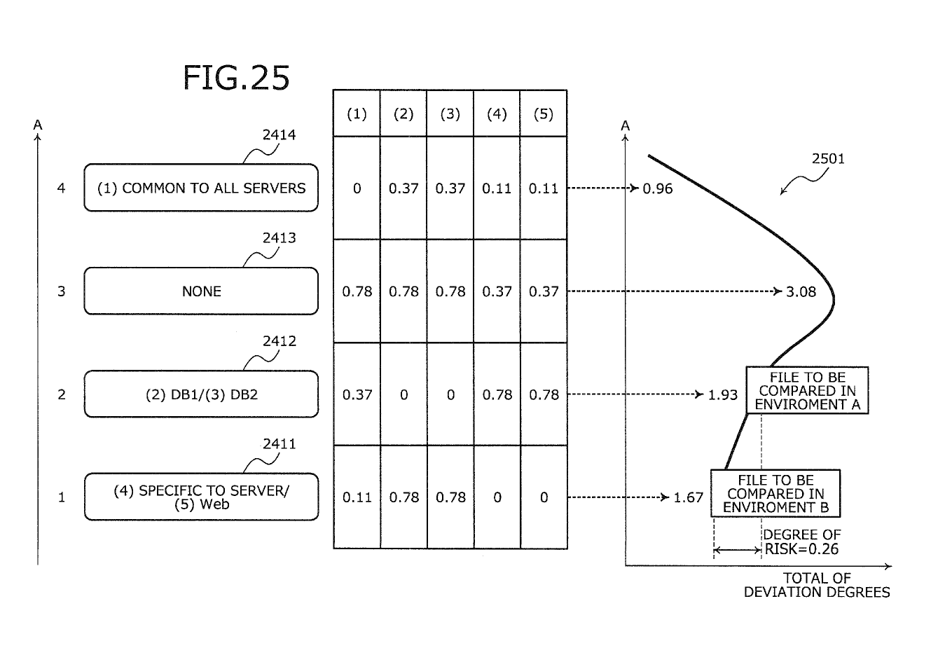

The degree of risk is an evaluation value indicating the extent of the possibility that the contents of a file are corrupt. The details of the degree of risk will be described with reference to FIG. 25. The file identifying apparatus 100 may employ the difference in the deviation degree between the first and the second layers or may employ the absolute value of the difference in the deviation degree between the first and the second layers, as the degree of risk, as an example of calculation of the degree of risk. In the example depicted in FIG. 1, the file identifying apparatus 100 determines seven as the degree of risk of the file f2, by subtracting the deviation degree of layer 1, which is one, from the deviation degree of layer 2, which is eight.

FIG. 2 is an explanatory diagram of an example of a cloud system to be evaluated. The cloud system 201 includes a master environment 202 that is in operation, environment A that is a development environment of the master environment 202, environment B that is a testing environment for the master environment 202, and environment C that is the real environment for the master environment 202, as environments; and the file identifying apparatus 100. The master environment 202, environments A to C, and the file identifying apparatus 100 are connected to each other by a network 211. Plural servers are present in each of the environments. The configuration of the master environment 202 and the configuration of each environment A to C resemble each other. Among environments A to C, the resources of environment A are relatively small, the resources of environment B are intermediate, and the resources of environment C are relatively large.

When the master environment 202 is expanded associated with an expansion of the service provided by the master environment 202, the cloud system 201 includes the plural environments to expedite the time when the expanded service can be provided. For example, environment A is an environment used to develop a function to provide a new service. Environment B is an environment used to test the new service. Environment C is an environment used to operate the new service.

The file identifying apparatus 100 is an apparatus configured to access the master environment 202 and environments A to C.

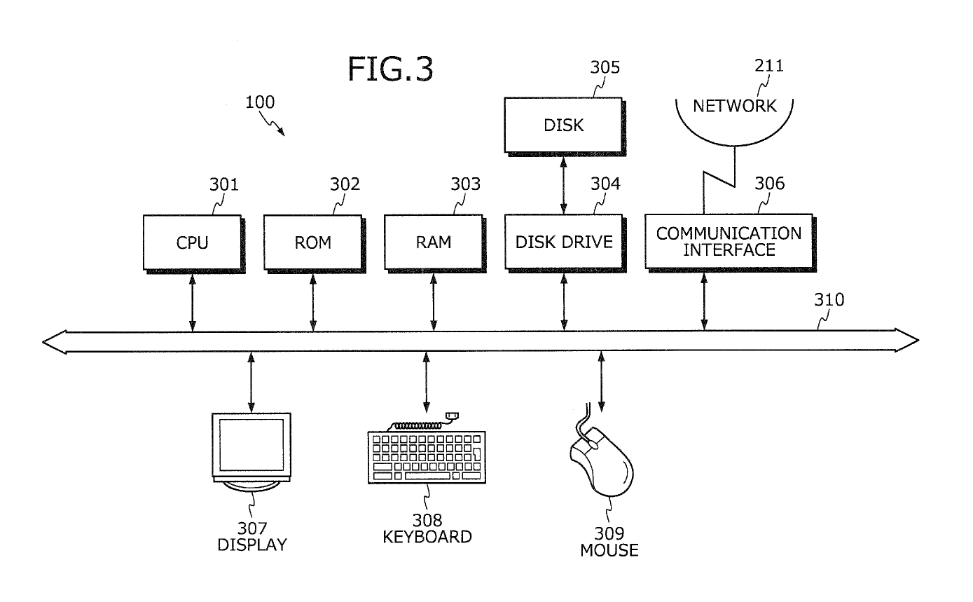

FIG. 3 is a block diagram of a hardware configuration of the file identifying apparatus. As depicted in FIG. 3, the file identifying apparatus 100 includes a central processing unit (CPU) 301, read-only memory (ROM) 302, random access memory (RAM) 303, a disk drive 304, a disk 305, a communication interface 306, a display 307, a keyboard 308, and a mouse 309, respectively connected by a bus 310.

The CPU 301 is a computation processing apparatus that governs overall control of the file identifying apparatus 100. The ROM 302 is non-volatile memory that stores programs such a boot program. The RAM 303 is volatile memory used as a work area of the CPU 301.

The disk drive 304, under the control of the CPU 301, controls the reading and writing of data with respect to the disk 305. For example, a magnetic disk drive, an optical disk drive, a solid state drive, and the like may be adopted as the disk drive 304. The disk 305 is non-volatile memory that stores data written thereto under the control of the disk drive 304. For example, when the disk drive 304 is a magnetic disk drive, the disk 305 may be a magnetic disk. When the disk drive 304 is an optical disk drive, the disk 305 may be an optical disk. Further, when the disk drive 304 is a solid state drive, the disk 305 may be semiconductor memory.

The communication interface 306 is a control apparatus that administers an internal interface with the network 211 and controls the input and output of data with respect to other apparatuses. The communication interface 306 is connected, via a communication line, to the network 211, which may be a local area network (LAN), a wide area network (WAN), the Internet, and the like. For example, a modem or a LAN adaptor may be employed as the communication apparatus 306.

The display 307 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 307.

The keyboard 308 includes, for example, keys for inputting text, numerals, and various instructions and performs the input of data. Alternatively, a touch-panel-type input pad or numeric keypad, etc. may be adopted. The mouse 309 is used to move the cursor, select a region, or move and change the size of windows. A track ball or a joy stick may be adopted provided each respectively has a function similar to a pointing device.

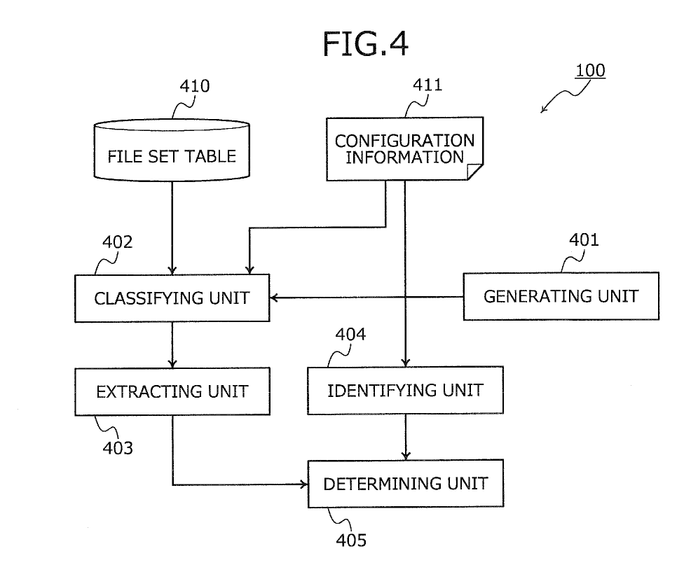

Functions of the file identifying apparatus 100 will be described. FIG. 4 is a block diagram of an example of a functional configuration of the file identifying apparatus. The file identifying apparatus 100 includes a generating unit 401, a classifying unit 402, an extracting unit 403, an identifying unit 404, and a determining unit 405. Functions of the units from the generating unit 401 to the determining unit 405 forming a control unit are implemented by causing the CPU 301 to execute programs stored in a storage apparatus. The storage apparatus is, for example, the ROM 302, the RAM 303, the disk 305, etc. depicted in FIG. 3. Functions of the units from the generating unit 401 to the determining unit 405 may be implemented by another CPU that executes the programs through the communication interface 306.

The file identifying apparatus 100 is configured to access a file set table 410 and configuration information 411. The file set table 410 and the configuration information 411 are stored in a storage apparatus such as the RAM 303 or the disk 305.

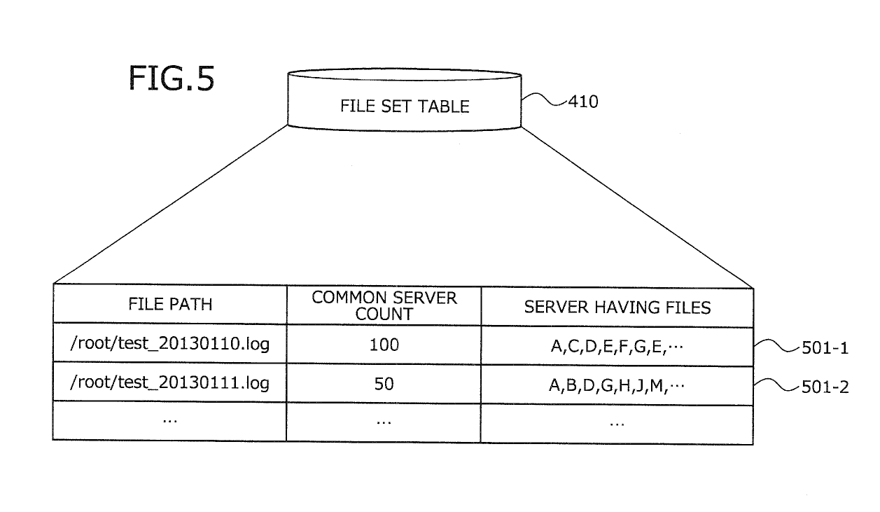

The file set table 410 is a table that stores the number of servers that among the files having the same name in a file group in an environment, have files of the same contents; and is present for each environment. An example of the contents of the file set table 410 will be described with reference to FIG. 5.

The configuration information 411 is information identifying the number of servers included in an environment. For example, the configuration information 411 is information that records the total number of servers included in the environment, the number of servers that each include predetermined hardware, and the number of servers that each have predetermined software installed therein. The “predetermined hardware” is hardware designated in advance by the user of the file identifying apparatus 100. The predetermined hardware may be, for example, an expansion disk. The “predetermined software” is software designated in advance by the user of the file identifying apparatus 100. The predetermined software may be, for example, web server software. Configuration information 411 is present for each environment.

The generating unit 401 generates plural layers based on first configuration information that indicates the number of servers included in a first server group and second configuration information that indicates the number of servers included in a second server group.

It is assumed, for example, that the configuration information 411 for environment A includes information indicating that the total number of servers included in environment A is four, and the configuration information 411 for environment B includes information indicating that the total number of servers included in environment B is eight. In this case, taking the smaller number between environments A and B, the generating unit 401 generates four layers. An example of generation of the layers will be described later with reference to FIG. 24. Information indicating the generated layers is stored in a storage area such as in the RAM 303 or the disk 305.

The classifying unit 402 classifies the files of the same name in the file group included in an environment into any one of the plural layers, based on the common server count stored in a file set table 410A for each of the plural environments. It is assumed, for example, that the file set table 410A stores information indicating that the common server count of the file f1 included in environment A is two. In this case, the classifying unit 402A classifies the file f1 into layer 2 among the layers 1 to 4.

The classifying unit 402 may classify the files of the same name in the file group into any one of the plural layers generated by the generating unit 401, based on the common server count stored in the configuration information 411 for each of the plural environments.

It is assumed, for example, that the configuration information 411 for environment A includes information indicating that the total number of servers included in environment A is four; the configuration information 411 for environment B includes information indicating that the total number of servers included in environment B is eight; and the generating unit 401 generates four layers. In this case, a classifying unit 402B classifies a file into a layer that corresponds to the quotient obtained by dividing the common server count for the file by two. For example, the classifying unit 402B classifies a file into a first layer when the common server count is one or two for the file. Similarly, the classifying unit 402B classifies a file into a second layer when the common server count is three or four for the file; classifies a file into a third layer when the common server count is five or six for the file; and classifies a file into a fourth layer when the common server count is seven or eight for the file.

When the total number of servers included in environments A and B differ, the classifying unit 402 corresponding to the environment including the greater total number of servers may designate servers corresponding to the smaller number from the server group included in this environment. As to which servers are designated, the servers may be designated by the user of the file identifying apparatus 100, etc., from the server group included in the environment, or may randomly be designated from the server group included in the environment. The classifying unit 402 corresponding to the environment including the greater total number of servers may classify the files of the same name into any one of the plural layers, based on the number of servers that are among the designated servers and include among the files of the same name, files of the same contents. The information concerning the layers into which the files are classified is stored in a storage area such as in the RAM 303 or the disk 305.

The extracting unit 403 extracts the files that have the same name and are classified into different layers from each other among the plural environments. For example, in the example depicted in FIG. 1, the extracting unit 403 extracts the files f2. The information identifying the extracted files is stored in a storage area such as in the RAM 303 or the disk 305.

Based on the configuration information 411, the identifying unit 404 identifies from the plural layers, one or more layers in which none of the contents of the files having the same name deviate between the files, when the files in the file groups included in an environment are classified.

It is assumed, for example, that the configuration information 411 has information indicating that the total number of servers included in an environment is 10; and 10 layers are present. In this case, the identifying unit 404 identifies from the plural layers, a tenth layer as the layer in which none of the contents of the files having the same name deviate, when the files of the file groups included in an environment are classified. It is assumed that the configuration information 411 has information indicating that the total number of servers included in an environment is 10, and that the number of servers each having the predetermined software installed therein is five; and 10 layers are present. In this case, the identifying unit 404 identifies from the plural layers, a tenth layer and a fifth layer as the layers in which none of the contents of the files having the same name deviate, when the files of the file groups included in an environment are classified. The information concerning the identified layers is stored in a storage area such as in the RAM 303 or the disk 305.

The determining unit 405 determines the degree of risk of the given file under evaluation, by referring to the deviation degree of each layer and based on the layer into which the files that are in different layers, have the same name, and have been extracted by the extracting unit 403 are classified. Among the layers into which the files of the same name and in different layers are classified, the layer into which the given file that is included in a server in environment A is classified will be referred to as “first layer” and the layer into which the given file that is included in a server in environment B is classified will be referred to as “second layer”.

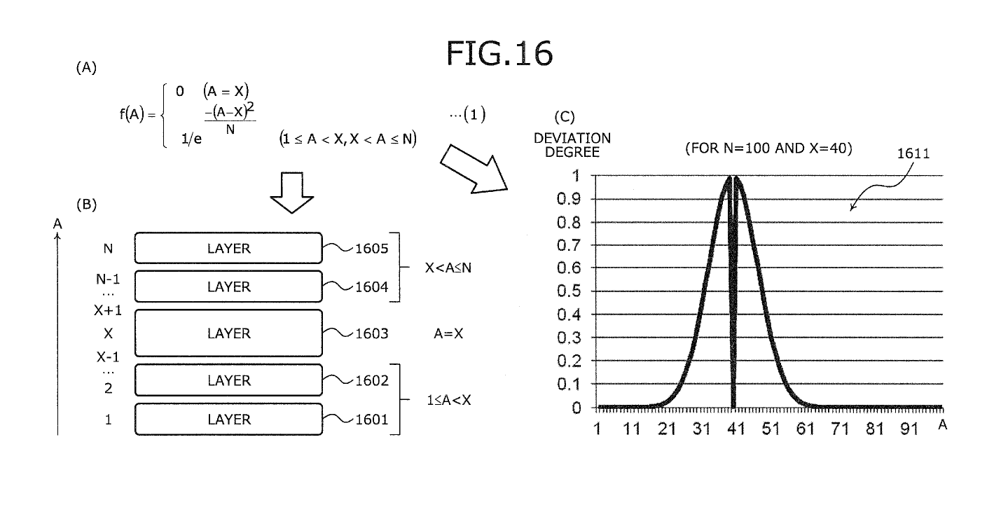

The determining unit 405 calculates the difference of a first deviation degree obtained by substituting the layer identified by the identifying unit 404 and the first layer into a first deviation function to obtain the deviation degree; and a second deviation degree obtained by substituting the layer identified by the identifying unit 404 and the second layer into the first deviation function. The determining unit 405 may determine the calculated value as the degree of risk of the given file. The “first deviation function” is a function expressing the deviation degree using the layer in which none of the contents of the files having the same name deviate from the others, when the files of the file groups included in the server group are classified, and the layer into which the file included in a server of the server group is classified. The first deviation function corresponds to a first example of the deviation function described later with reference to FIGS. 16A, 16B, and 16C.

When the identifying unit 404 identifies plural layers, the determining unit 405 calculates the difference of the first and the second deviation degrees, for each of the identified layers. The determining unit 405 may determine the sum of the differences of the first and the second deviation degrees for each of the identified layers, as the degree of risk of the given file.

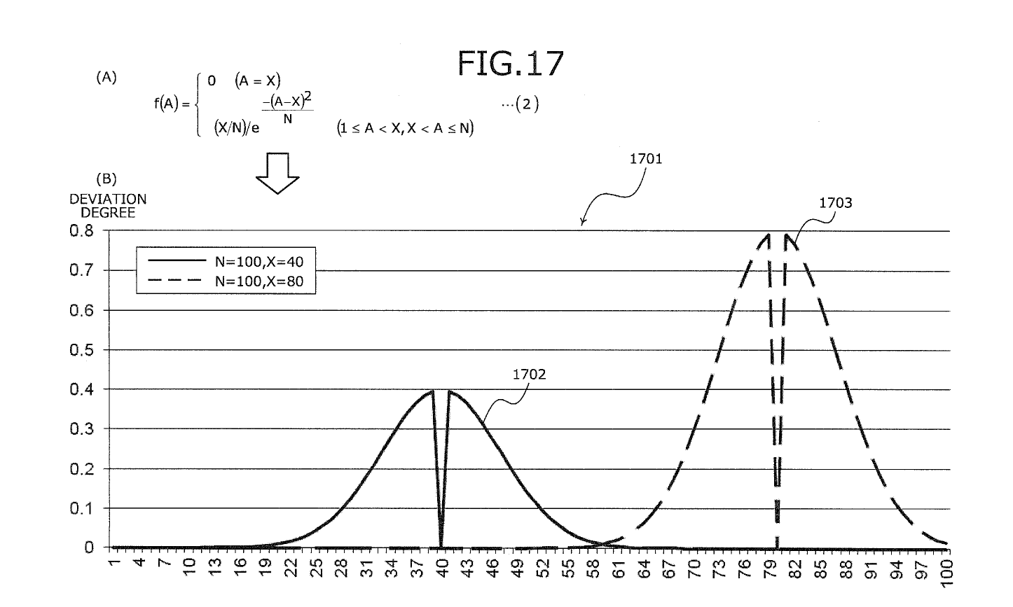

The determining unit 405 calculates the first deviation degree by substituting the number of servers identified by the configuration information 411, the layer identified by the identifying unit 404, and the first layer into a second deviation function to obtain the deviation degree. The determining unit 405 calculates the second deviation degree by substituting the number of servers identified by the configuration information 411, the layer identified by the identifying unit 404, and the second layer into the second deviation function. The determining unit 405 may determine the degree of risk of the given file by calculating the difference of the first and the second deviation degrees. The “second deviation function” is a function expressing the deviation degree using the number of servers identified from the configuration information, the layer in which none of the contents of the files having the same name deviate from the others, when the files of the file group included in the server group are classified, and the layer into which the files included in a server of the server group are classified. The second deviation function corresponds to a second example of the deviation function described later with reference to FIG. 17.

The determining unit 405 may calculate the difference of the first and the second deviation degrees, or may calculate the absolute value of the difference of the first and the second deviation degrees, as a difference between the first and the second deviation degrees. The determined degree of risk of the given file is stored in a storage area such as in the RAM 303 or the disk 305.

FIG. 5 is an explanatory diagram of an example of the contents of the file set table. The file set table 410 is a table that stores the common server count for the files included in the environment and is generated for each environment. The file set table 410 depicted in FIG. 5 includes records 501-1 and 501-2, and has three fields for the file path, the common server count, and the server having the files. The “file path” field stores a full path of a file. The “common server count” field stores the number of servers that include the file designated in the file path field and that include the files having identical contents. The “server having files” field stores identification information concerning the server that includes the file designated in the file path field.

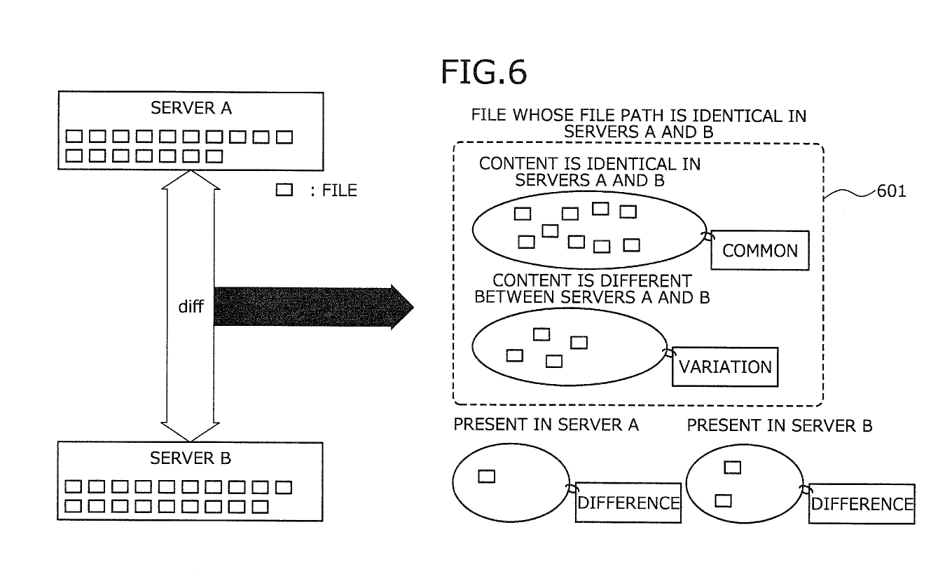

For example, the record 501-1 indicates that servers each having a file path “/root/test_{—}20130110.log” are “A”, “B”, “C”, “D”, “E”, “F”, “G”, “E”, . . . ; and 100 servers have identical contents, among the servers that include the files. An example of generation of the file set table 410 will be described with reference to FIGS. 6 to 9. In FIGS. 6 to 9, each file is depicted by a rectangle.

FIG. 6 is an explanatory diagram (Part I) of an example of generation of the file set table. The file identifying apparatus 100 classifies the files into file classes “common”, “variation”, and “difference” based on the result of “diff” among the servers included in an environment in which a problem has occurred.

For example, the file identifying apparatus 100 determines first for servers A and B included in environment A, in which a problem has occurred, whether files having the same file path are present in the servers A and B. In this case, all the files present in the servers A and B are to be processed.

If the file identifying apparatus 100 determines that such files are present, the file identifying apparatus 100, using a “diff” tool, determines whether the contents of the files included in the servers A and B are identical. The file identifying apparatus 100 classifies the files having identical contents into the file class “common”, classifies the files having different contents included in the servers A and B into the file class “variation”, and classifies the files present in the server A and not present in the server B and the files present in the server B and not present in the server A into the file class “difference”.

A set 601 includes files whose file paths are identical between the servers A and B. The contents of the files included in a set AB are identical between the servers A and B and therefore, the set AB represents that the files have been classified to the file class “common” by the file identifying apparatus 100. The contents of the files included in a set A-B are different between the servers A and B and therefore, the set A-B represents that the files have been classified to the file class “variation” by the file identifying apparatus 100. The files included in a set A are present in the server A and not present in the server B and therefore, the set A represents that the files have been classified to the file class “difference” by the file identifying apparatus 100. Similarly, the files included in a set B are present in the server B and not present in the server A and therefore, the set B represents that the files have been classified to the file class “difference” by the file identifying apparatus 100.

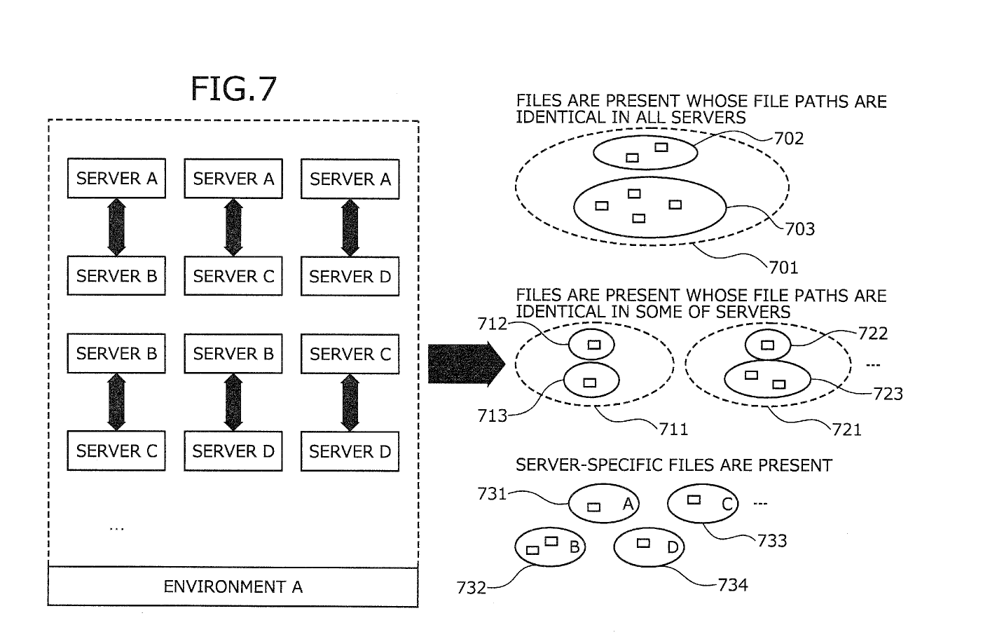

FIG. 7 is an explanatory diagram (Part II) of the example of generation of the file set table. Similarly with respect to the result of “diff” between the servers A and B depicted in FIG. 6, the file identifying apparatus 100 classifies the files into “common”, “variation”, and “difference” for all combinations between the servers other than those of the servers A and B included in environment A.

In the example of FIG. 7, the file identifying apparatus 100 classifies the files into any one of “common”, “variation”, and “difference” for the combinations of servers A and C, servers A and D, servers B and C, servers B and D, servers C and D, . . . .

After classifying the files into “common”, “variation”, and “difference” for each combination of servers included in environment A, the file identifying apparatus 100 generates a set, for each number of servers that includes files having the same file path, based on the classification result.

For example, as depicted in FIG. 7, the file identifying apparatus 100 includes in a set 701 the files whose file classes are “common” or “variation” in all the combinations of the servers, among the files having the same file path. The set 701 is a set that includes the files present in each of the servers and having the same file path; and includes a set 702 that includes the files respectively classified into “common” and a set 703 that includes the files respectively classified into “variation”.

The file identifying apparatus 100 includes into sets 711, 721, . . . , the files whose file classes are “difference” for a combination of the servers and whose file classes are “common” or “variation” for another combination of the servers, among the files having the same file path. The sets 711 and 721 are each a set that includes files present in some of the servers and having the same file path. The combinations of the servers having the files present therein are different between the sets 711 and 721. The file identifying apparatus 100 includes in sets 731, 732, 733, 734, . . . , the files present in one server.

For simplification of the description, it is assumed that the set 711 is a set that includes the files respectively present in servers A and B and having the same file path; and that the set 721 is a set that includes the files respectively present in servers A and C and having the same file path. The set 711 includes a set 712 that includes the files whose file classes are respectively “difference” for each combination of server A and a server other than server B and each combination of server B and a server other than server A, and whose file classes are respectively “common” for the combination of servers A and B. The set 711 further includes a set 713 that includes the files whose file classes are respectively “difference” for each combination of server A and a server other than server B and each combination of server B and a server other than the server A, and whose file classes are respectively “variation” for the combination of servers A and B.

The set 721 includes a set 722 that includes the files whose file classes are respectively “difference” for each combination of server A and a server other than server C and each combination of server C and a server other than server A, and whose file classes are respectively “common” for the combination of servers A and C. The set 721 further includes a set 723 that includes the files whose file classes are respectively “difference” for each combination of server A and a server other than server C and each combination of server C and a server other than server A, and whose file classes are respectively “variation” for the combination of servers A and C.

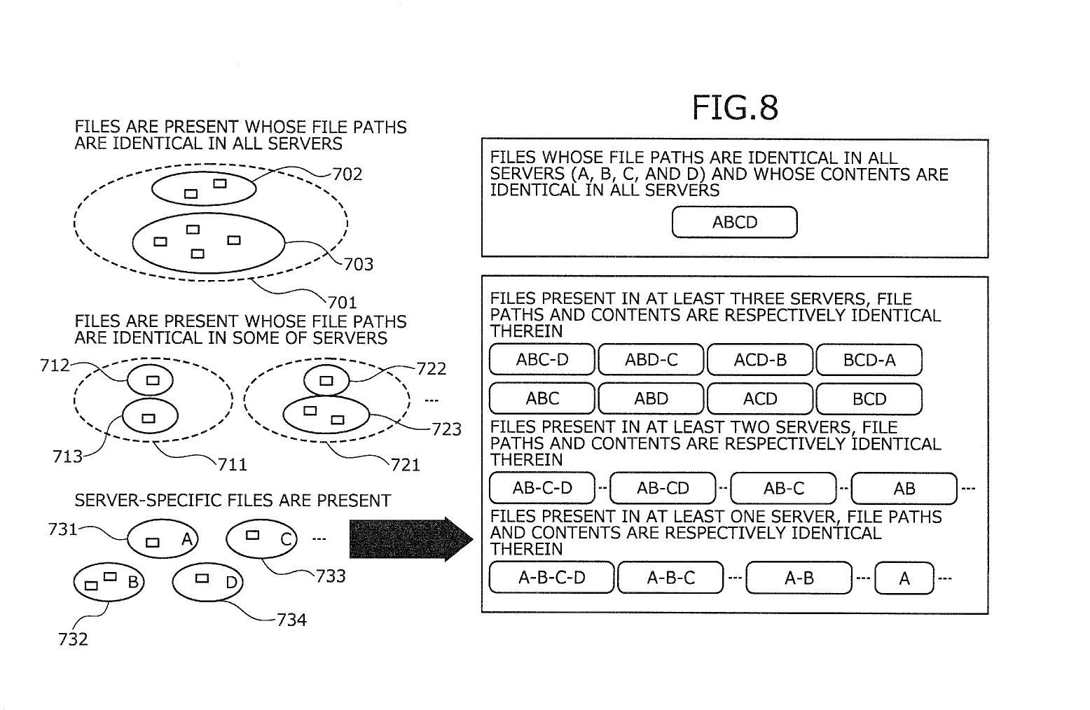

FIG. 8 is an explanatory diagram (Part III) of the example of generation of the file set table. After generating the sets for the numbers of the servers that include the files having the same file path, the file identifying apparatus 100 classifies the files into sets of files having identical contents, based on the file classes, for the sets respectively for each number of servers that include the files having the same file path. For simplification of the description, in FIG. 8, environment A includes the four severs A, B, C, and D.

For example, the file identifying apparatus 100 regards the set 702 as “set ABCD”. The set ABCD includes files whose file classes are respectively “common” for all combinations of the servers. In other words, the set ABCD includes the files that are present in each of the servers, have the same file path, and include identical contents.

Among the files included in the set 703, the file identifying apparatus 100 includes in a set ABC-D, the files whose contents are identical in servers A, B, and C, and in server D, differ from that in servers A, B, and C. Hereinafter, identification information concerning the servers that include the files having the same contents are concatenated continuously, and identification information concerning the servers that include the files whose contents are different from each other are concatenated by “-”, as a notation of the symbols of the sets. For example, among the files included in the set 703, a set AB-C-D includes the files whose contents are identical in the servers A and B, and in servers C and D, differ from that in servers A and B.

As depicted in FIG. 8, sets that respectively include files that are present in at least three servers, have the same file path, and have identical contents are sets ABC-D, ABD-C, ACD-B, BCD-A, ABC, ABD, ACD, and BCD. The “files that are present in at least three servers, have the same file path, and have identical contents” are, in other words, the files for which the number of combinations of servers that include the files whose classes are respectively “common” is three, the number of server combinations being obtained by selecting two servers from three servers. For example, the files included in the set ABC-D are the files whose file classes are each “common” for the combinations of the servers A and B, A and C, and B and C, and whose file classes are each “variation” for the combinations of the servers A and D, B and D, and C and D.

The sets that respectively include the files that are present in at least two servers, have the same file paths, and include identical contents are sets AB-C-D, AB-CD, . . . , AB-C, . . . , AB, . . . . The “sets that respectively include the files that are present in at least two servers, have the same file path, and have identical contents” are, in other words, the files for which the number of combinations of servers that include files whose classes are respectively “common” is one or two. For example, the files included in the set AB-C-D are the files whose file classes are each “common” for the combination of the servers A and B, and whose file classes are each “variation” for the combinations of the servers A and C, A and D, B and C, B and D, and C and D. The files included in the set AB-CD are the files whose file classes are each “common” for the combinations of the servers A and B, and C and D, and whose file classes are each “variation” for the combinations of the servers A and C, A and D, B and C, and B and D.

The sets that respectively include the files that are present in at least one server and whose contents differ from each other when their file paths are same as each other are sets A-B-C-D, A-B-C, . . . , A-B, . . . , A, . . . . The “files that are present in at least one server and whose contents differ from each other when their file paths are same as each other” are, in other words, the files for which the number of combinations of the servers including files whose classes are each “common” is zero. For example, the files included in the set A-B-C-D are the files whose classes are each “variation” in all the combinations of the servers.

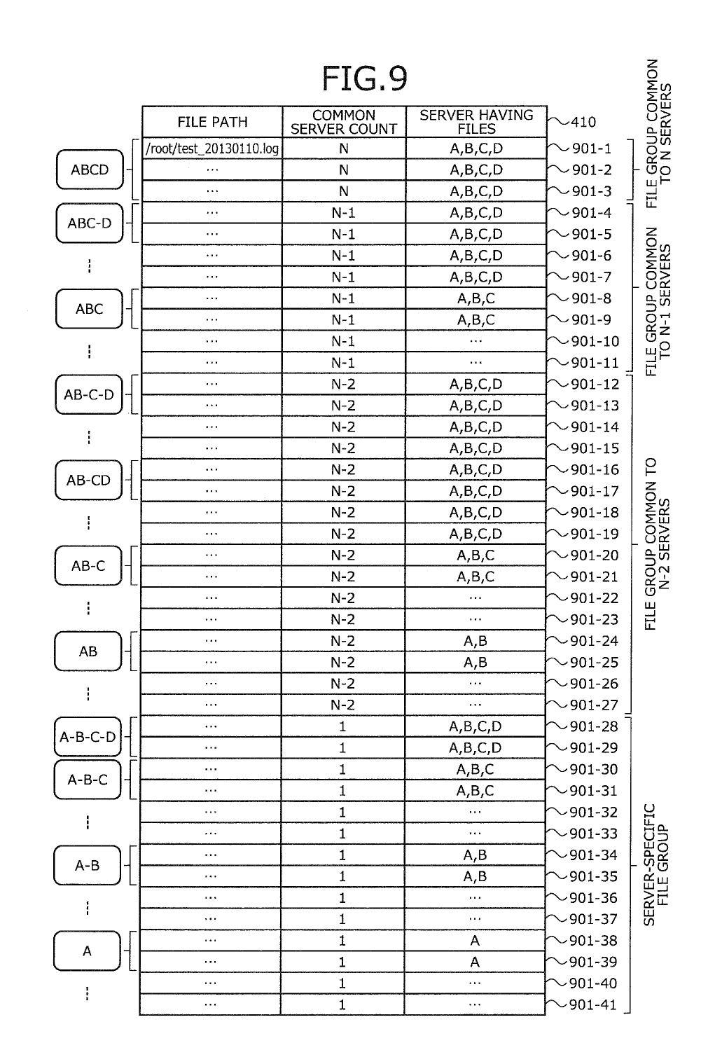

FIG. 9 is an explanatory diagram (Part IV) of the example of generation of the file set table. After classifying the files into sets that each include the files having identical contents, the file identifying apparatus 100 generates the file set table 410 from the sets that each include the files having identical contents. In the example of FIG. 9, the number of servers included in the environment is represented by “N”; and similarly with respect to the example depicted in FIG. 8, it is assumed that environment A includes the four servers A, B, C, and D.

For example, for the files included in the set ABCD, the file identifying apparatus 100 adds to the file set table 410, a record that stores identification information that indicates “file path of the file” for the file path, “N” for the common server count, and “the servers A to D” for the servers including the files. In the example depicted in FIG. 9, for the files included in the set ABCD, the file identifying apparatus 100 adds to the file set table 410, records 901-1 to 901-3 as the file group common to the N servers.

For the files included in the set ABC-D, the file identifying apparatus 100 adds to the file set table 410, a record that stores identification information that indicates “file path” for the file path, “N−1” for the common server count, and “the servers A to D” for the servers including the files. In the example of FIG. 9, for the files included in the set ABC-D, the file identifying apparatus 100 adds to the file set table 410, records 901-4 and 901-5. Similarly, for the files included in the set ABC, the file identifying apparatus 100 adds to the file set table 410, records 901-8 and 901-9. The file identifying apparatus 100 adds to the file set table 410, the records 901-4 to 901-11, as the file group common to the N−1 servers.

For the files included in the set AB-C-D, the file identifying apparatus 100 adds to the file set table 410, a record that stores identification information that indicates “file path” for the file path, “N−2” for the common server count, and “the servers A to D” for the servers including the files. In the example depicted in FIG. 9, for the files included in the set AB-C-D, the file identifying apparatus 100 adds to the file set table 410, records 901-12 and 901-13. Similarly, for the files included in the set AB-CD, the file identifying apparatus 100 adds to the file set table 410, records 901-16 and 901-17. For the files included in the set AB-C, the file identifying apparatus 100 adds to the file set table 410, records 901-20 and 901-21. For the files included in the set AB, the file identifying apparatus 100 adds to the file set table 410, records 901-24 and 901-25. The file identifying apparatus 100 adds to the file set table 410, the records 901-12 to 901-27, as the file group common to N−2 servers.

For the files included in the set A-B-C-D, the file identifying apparatus 100 adds to the file set table 410, a record that stores identification information that indicates “file path” for the file path, “1” for the common server count, and “the servers A to D” for the servers including the files. In the example depicted in FIG. 9, for the files included in the set A-B-C-D, the file identifying apparatus 100 adds to the file set table 410, records 901-28 and 901-29. Similarly, for the files included in the set A-B-C, the file identifying apparatus 100 adds to the file set table 410, records 901-30 and 901-31. For the files included in the set A-B, the file identifying apparatus 100 adds to the file set table 410, records 901-34 and 901-35. For the files included in the set A, the file identifying apparatus 100 adds to the file set table 410, records 901-38 and 901-39. The file identifying apparatus 100 adds to the file set table 410, the records 901-28 to 901-41, as a server-specific file group.

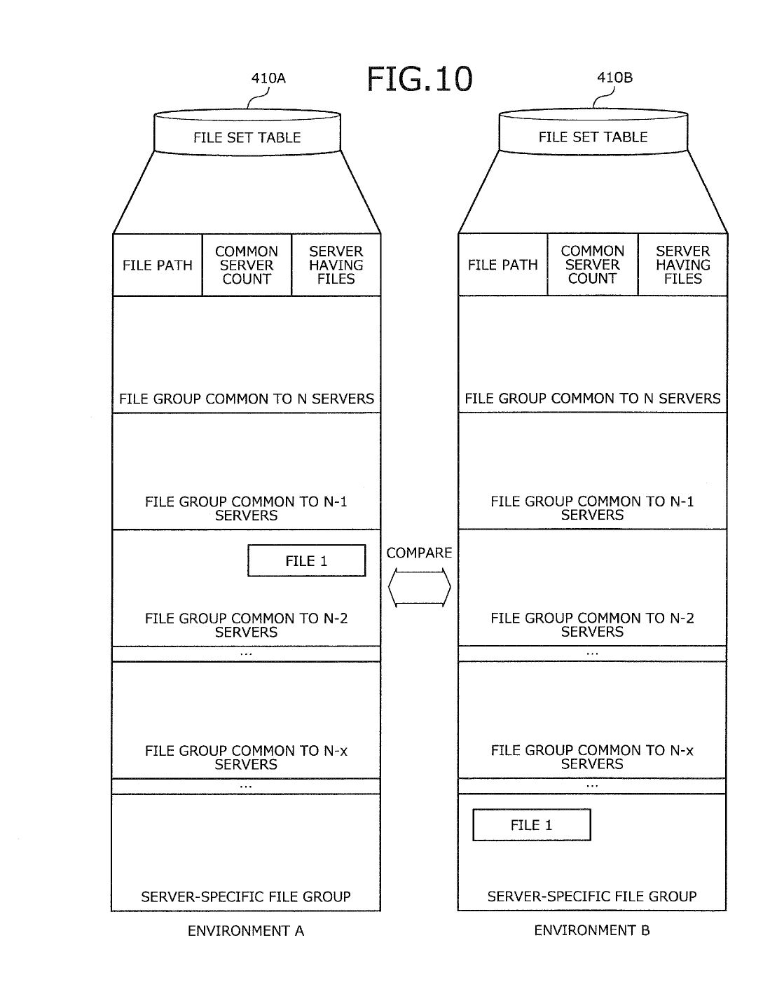

An example of extraction of files whose common server counts differ will be described with reference to FIG. 10.

FIG. 10 is an explanatory diagram of an example of extraction of the files whose common server counts differ. The file identifying apparatus 100 generates the file set table 410A for environment A to be a comparison reference environment and a file set table 410B for environment B to be the environment to be compared, and extracts the files whose common server counts differ, as risky files. The environment B includes configuration information similar to that of environment A.

FIG. 10 collectively depicts the file group common to the same servers, for the records of the file set tables 410A and 410B respectively for environments A and B.

A file whose common server counts differ can be regarded as a risky file because the difference may be generated because the variation of the setting is left not returned when the common server count differs depending on the environment, even for the same file path.

In the example depicted FIG. 10, though file 1 is included in a file group common to N−2 servers in the file set table 410A, file 1 is included in a file group specific to a server in the file set table 410B and therefore, the common server counts differ. In this manner, the file identifying apparatus 100 extracts a file whose common server counts differ.

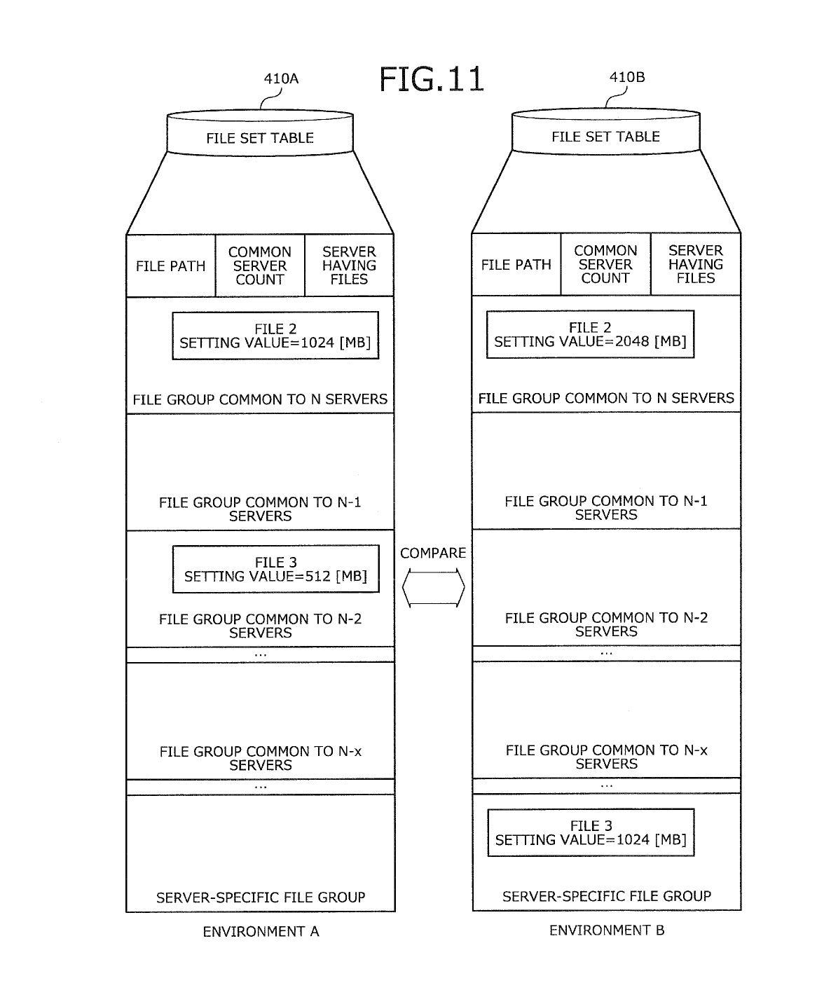

FIG. 11 is an explanatory diagram of an example of the risk for the file whose common server counts differ. The presence or absence of the risk will be described with reference to FIG. 11 using file 2 whose common server counts do not differ from each other between environments A and B and file 3 whose common server counts differ between environments A and B.

The setting value of file 2 is 1,024 [MB] in environment A and is 2,048 [MB] in environment B, and file 2 belongs to a file group common to N servers in both of environments A and B. The setting values of file 2 differ from each other between environments A and B. However, when the configuration information is similar between environments A and B, the sets of the common server counts to which the file belongs are highly likely to be same as each other. Therefore, the file identifying apparatus 100 identifies file 2 to not be a risky file.

On the other hand, the setting value of file 3 is 512 [MB] in environment A and is 1,024 [MB] in environment B, and file 2 belongs to a file group common to N−2 servers in environment A and to a file group specific to a server in environment B. For file 3, though the configuration information is similar between environments A and B, the sets of the common server counts to which the file belongs are not same. Therefore, the file identifying apparatus 100 identifies file 3 to be a risky file.

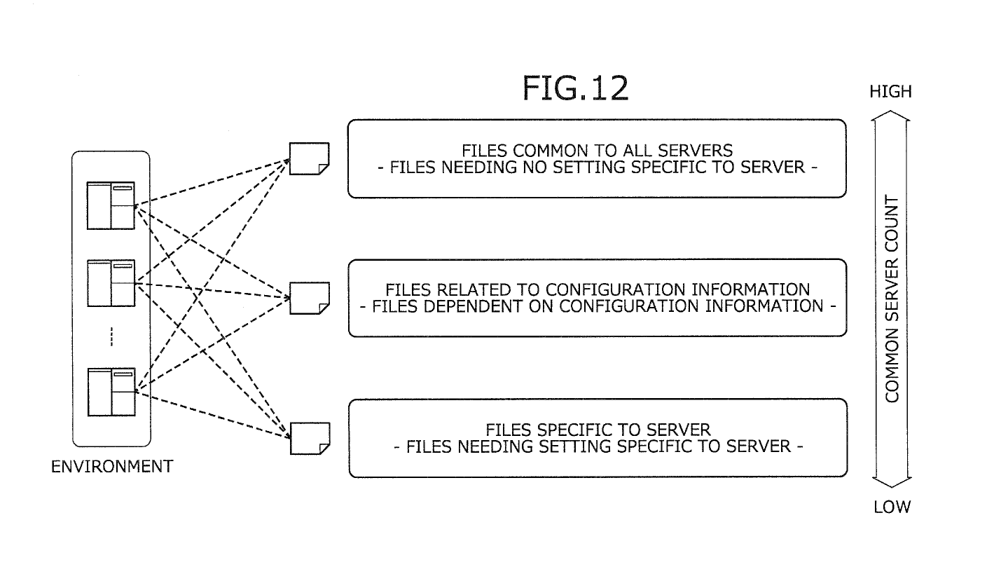

Based on the conditions depicted in FIGS. 10 and 11, the sets of the common server counts differ between the environments and therefore, plural risky files are highly likely to be identified. The file identifying apparatus 100 determines a high-risk file of the risky files. The relation between the configuration information and the common server count that is used in the determination of the high-risk file will be described with reference to FIG. 12.

FIG. 12 is an explanatory diagram of the relation between the configuration information and the common server count. For a file in an environment, the common server count tends to be determined to some extent corresponding to the following attributes. A file common to all the servers is highly likely to belong to a set whose common server count is high. A file specific to a server is highly likely to belong to a set whose common server count is low. A file related to the configuration information is highly likely to belong to a set whose common server count depends on the configuration information.

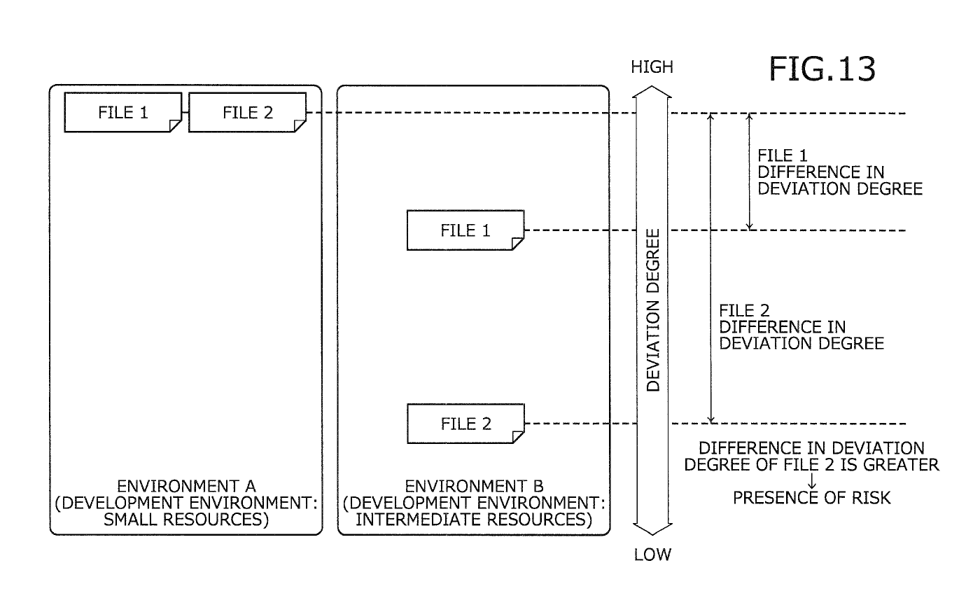

It is assumed, for example, that an environment includes the servers A, B, C, and D; and the configuration information of the environment is information indicating that software A is installed in each of the servers A and B. In this case, the setting file of the software A is highly likely to belong to a set whose common server count is two because the software A is installed in each of the servers A and B. An example will be described with reference to FIGS. 13 to 19 where a high-risk file among the risky files is determined using the relation between the configuration information and the common server count.

FIG. 13 is an explanatory diagram of the relation between the risk and the deviation degree. The file identifying apparatus 100 determines whether the risk of a given file to be compared among the risky files is high, using the deviation degrees for the given file in the different environments. When the absolute value of the difference between the deviation degrees for the given file is high though the configuration information is similar for the different environments, the file identifying apparatus 100 determines that the risk of the given file is high. The deviation degree for the given file is a value that depends on the configuration information and the common server count, and is a value that indicates the extent to which the contents of the file deviate from the contents of a file having the same name as the given file, in another server in the environment. Details of the deviation degree for the given file will be described later with reference to FIGS. 14A, 14B, and 14C.

In FIG. 13, files 1 and 2 are present in environment A that includes small resources and environment B that includes intermediate resources and whose configuration information is similar to that of environment A. In the example depicted in FIG. 13, the absolute value of the difference of the deviation degrees of file 2 is greater than the absolute value of the difference of the deviation degrees of file 1. Therefore, the file identifying apparatus 100 determines that the risk of file 2 is higher.

FIGS. 14A, 14B, and 14C are explanatory diagrams of the deviation degree for the given file. For example, the deviation degree from the given file becomes small when the contents of the given file are all the same or all differ between the servers in the environment, and becomes great when only the contents of files included in some of the servers differ from the others. FIG. 14A depicts files respectively having a language setting described therein in an environment, as files to be compared. As depicted in FIG. 14A, it is assumed that in the environment, the language setting of the files included in all the servers is “JP” representing the Japanese language. In this case, the deviation degree is minimal.

Similarly, FIG. 14B depicts files respectively having a language setting described therein in the environment, as the files to be compared. As depicted in FIG. 14B, it is assumed that in the environment, the language setting of each of the files included in a server is “ENG” representing the English language and the language setting of each of the files included in servers other than the server is “JP”. In this case, the deviation degree becomes maximal. As depicted in FIG. 14B, a possible cause of only one given server including different contents is that among the files respectively having identical contents in the environment, the files of the one given server are subject to a problem of a program, an unintended setting change by an operation, etc., by the manager, or a neglect of returning the contents to the original contents. In this manner, the one given server may include different contents consequent to an unintended problem and therefore, the deviation degree becomes great.

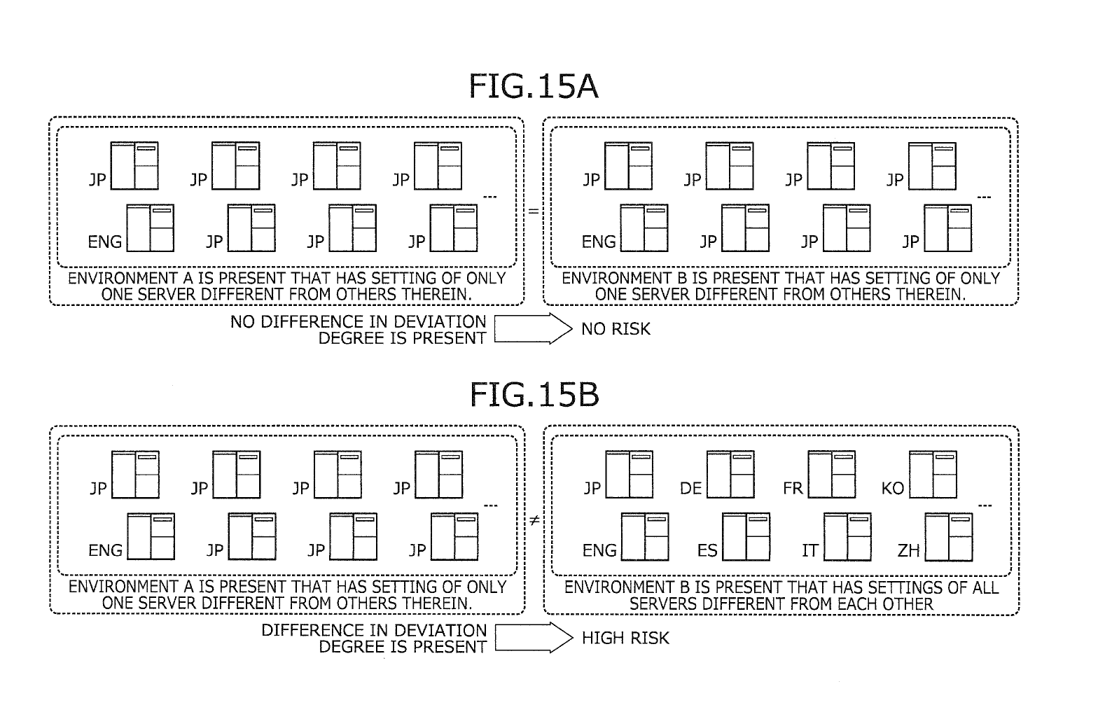

FIG. 14C depicts files respectively having an Internet protocol (IP) address setting described therein in the environment, as the files to be compared. As depicted in FIG. 14C, it is assumed that in the environment, the IP addresses of all the servers differ from each other. In this case, the deviation degree is small. The deviation degree is small because when all the values differ from each other, the contents may intentionally be set to differ from each other such that the IP addresses are each uniquely identified. In FIGS. 15A and 15B, the deviation degree for the files to be compared between the environments will be described with reference to FIGS. 15A and 15B.

FIGS. 15A and 15B are explanatory diagrams of the deviation degree for given files to be compared between the environments. The deviation degree for the given files to be compared is highly likely to be similar between the environments whose configuration information is similar. In this embodiment, since the deviation degree for the given files to be compared is highly likely to be similar between the environments whose configuration information is similar, it is determined that a file whose deviation degrees for the given files to be compared differ from each other is a high-risk file.

In FIG. 15A, in environment A, as to the language setting of the given files to be compared, the language setting of the files of only one given server is “ENG” and that of the files of the other servers is “JP” and therefore, the deviation degree for the given files to be compared is great. Similarly, in environment B, as to the language setting of the given files to be compared, the language setting of the files of only one given server is “ENG” and that of the files of the other servers is “JP” and therefore, the deviation degree for the given files to be compared is great. Therefore, in FIG. 15A, no difference is present in the deviation degree between environments A and B and therefore, the file identifying apparatus 100 determines that no risk is present for the given files that each have the language setting described therein.

In FIG. 15B, in environment A, as to the language setting of the given files to be compared, the language setting of the files of only one given server is “ENG” and that of the files of the other servers is “JP” and therefore, the deviation degree is great. In environment B, as to the language setting of the given files, the contents of the language setting are all different from each other and therefore, the deviation degree is small. Therefore, in FIG. 15B, the file identifying apparatus 100 determines that a risk is present for the given files respectively having the language setting described therein because a difference is present in the deviation degree between environments A and B.

The first and the second examples of the deviation function to obtain the deviation degree will be described with reference to FIGS. 16 and 17. The deviation function according to the first and the second examples is a function that provides zero as the minimal value and one as the maximal value for the deviation degree obtained.

FIG. 16 is an explanatory diagram of the first example of the deviation function. The file identifying apparatus 100 performs a calculation for the deviation function f(A), using Eq. (1) below and also depicted in (A) of FIG. 16.

$$f ( A ) = \{ \begin{matrix}0 & ( A = X ) \\ 1 / {e}^{\frac{- {( A - X )}^{2}}{N}} & ( 1 \leq A < X , X < A \leq N )\end{matrix} \qquad ( 1 )$$

Where, “e” is the base of natural logarithm; “N” is the total number of servers included in the environment; “X” is a value at which it is considered that the contents of files having the same name do not deviate when the files of a file group included in environment A are classified and is, for example, the number of servers each including the files identified from the configuration information; and “A” is the common server count.

(B) in FIG. 16 depicts the layers correlated with the sets corresponding to the values of “A”. The file identifying apparatus 100 sets X and N in Eq. (1) and thereby, prepares the deviation function for the layer for which it is identified that the common server count is X. As depicted in (B), the file identifying apparatus 100 classifies the files into a layer 1601 for which A=1 is identified, a layer 1602 for which A=2 to X−1 is identified, a layer 1603 for which A=X is identified, a layer 1604 for which A=X+1 to N−1 is identified, and a layer 1605 for which A=N is identified.

(C) in FIG. 16 depicts an example where the relation between A and the value of the deviation degree is presented in a graph 1611 as the result of the calculation of Eq. (1). The axis of abscissa of the graph 1611 represents “A” and the axis of ordinate thereof represents the deviation degree. The graph 1611 is a graph presenting a curve drawn according to Eq. (1) when N and X are set to respectively be 100 and 40. As presented by the graph 1611, the value of the deviation degree is zero when A is A=40 and the value thereof is maximal when A is A=39 or A=41.

FIG. 17 is an explanatory diagram of the second example of the deviation function. As depicted also in (A) of FIG. 17, the file identifying apparatus 100 calculates the deviation function f(A) using Eq. (2) below.

$$f ( A ) = \{ \begin{matrix}0 & ( A = X ) \\ ( X / N ) / {e}^{\frac{- {( A - X )}^{2}}{N}} & ( 1 \leq A < X , X < A \leq N )\end{matrix} \qquad ( 2 )$$

“e”, “N”, and “X” are defined similarly to those of Eq. (1). Compared to Eq. (1), the degree of risk of the configuration involving more servers can be evaluated to be higher based on Eq. (2) by adding the number of servers identified from the configuration information.

(B) in FIG. 17 depicts an example where the relation between A and the value of the deviation degree is presented in a graph 1701 as the result of the calculation of Eq. (2). The axis of abscissa of the graph 1701 represents “A” and the axis of ordinate thereof represents the deviation degree. A solid line 1702 in the graph 1701 is a curve drawn according to Eq. (2) when N and X are respectively set to be 100 and 40. A dashed line 1703 in the graph 1701 is a curves drawn according to Eq. (2) when N and X are respectively set to be 100 and 80. As presented by the solid line 1702 and the dashed line 1703, the value of the deviation degree obtained when A is A=79 or A=81 with N and X that are N=100 and X=80 is greater than that of the deviation degree obtained when A is A=39 or A=41 with N and X that are N=100 and X=40.

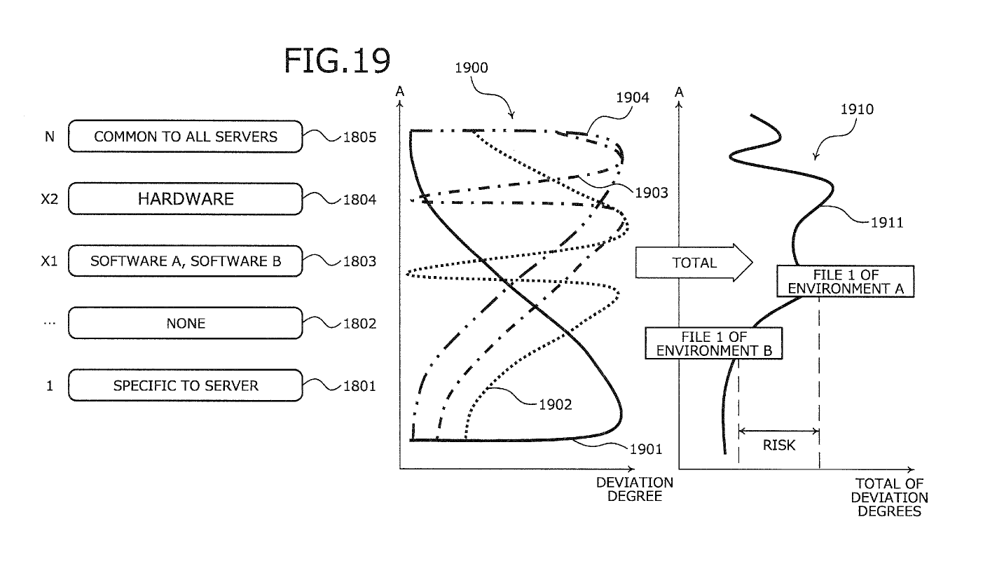

A specific example where the value of the deviation degree is obtained using the deviation function will be described with reference to FIGS. 18 and 19.

FIG. 18 is an explanatory diagram (Part I) of an example of calculation of the value of the deviation degree based on the deviation function. The file identifying apparatus 100 generates plural layers based on the configuration information of the environment, and correlates the values one to N that can be taken by the common server count A with the layer of the number of servers respectively having software identified based on the configuration information installed therein, and the layer of the number of servers respectively using hardware.

In the example depicted in FIG. 18, the file identifying apparatus 100 generates five layers including first to fifth layers, based on the configuration information, and identifies based on the configuration information, the layer in which the contents of the files having the same name do not deviate when the files of the file groups included in the environment are classified, from the first to the fifth layers.

For example, the contents of the files of each file group specific to a server, among the file groups included in the environment are highly likely to be different from each other and therefore, the file identifying apparatus 100 identifies a layer 1801 whose A is A=1 for the file group specific to the server. Similarly, a file group related to software A and software B of the file groups included in the environment is highly likely to have a common server count that is X1 and therefore, the file identifying apparatus 100 identifies a layer 1803 whose A is A=X1 for the file group related to the software A and B. A file group related to hardware C of the file groups included in the environment is highly likely to have a common server count that is X2 and therefore, the file identifying apparatus 100 identifies a layer 1804 whose A is A=X2 for the file group related to the hardware C. The file group common to all the servers of the file groups included by the environment is highly likely to have a common server count that is N and therefore, the file identifying apparatus 100 identifies a layer 1805 whose A is A=N for the file group common to all the servers.

FIG. 19 is an explanatory diagram (Part II) of the example of calculation of the value of the deviation degree, using the deviation function. After classifying the numbers A of the common servers into the layers, the file identifying apparatus 100 generates the deviation function for each of the layers; obtains the sum of the values of the deviation degrees for the layers for A that is A=1 to N, from the generated deviation function; and determines the degree of risk of the files to be compared to be the absolute value of the difference of the sum of the values of the deviation degrees for the layers into which the given file in environment A are classified, and the sum of the values of the deviation degrees for the layers into which the given file in environment B are classified.

In the example depicted in FIG. 19, the file identifying apparatus 100 generates the deviation functions for the layers 1801 to 1805, and obtains the sum of the values of the deviation degrees of the layers for A that is one to N, from the generated deviation functions. A graph 1900 presents a curve drawn by plotting the values of the deviation degrees obtained by substituting A that is A=1 to N into the generated deviation functions. A graph 1910 presents a curve formed by plotting the sum of the values of the deviation functions for the layers for A that is A=1 to N. The horizontal axis of the graph 1900 represents the deviation degree and that of the graph 1910 represents the sum of the values of the deviation degrees. The vertical axis of each of the graphs 1900 and 1910 represents the common server count A.

For example, the file identifying apparatus 100 generates the deviation function for X that is X=1 as the deviation function for layer 1801. A solid line 1901 in the graph 1900 is the curve formed by plotting the values of the deviation degrees obtained by substituting A that is A=1 to N into the deviation function for X that is X=1. The deviation function for layer 1802 has no item for the configuration information to belong to and therefore, the file identifying apparatus 100 generates no deviation function for layer 1802.

The file identifying apparatus 100 generates the deviation function for X that is X=X1 as the deviation function for layer 1803. A dotted line 1902 in the graph 1900 is the curve formed by plotting the values of the deviation degrees obtained by substituting A that is A=1 to N into the deviation function for X that is X=X1.

The file identifying apparatus 100 generates the deviation function for X that is X=X2 as the deviation function for layer 1804. A dashed single-dotted line 1903 in the graph 1900 is the curve formed by plotting the values of the deviation degrees obtained by substituting A that is A=1 to N into the deviation function for X that is X=X2.

The file identifying apparatus 100 generates the deviation function for X that is X=N as the deviation function for layer 1805. A dashed double-dotted line 1904 in the graph 1900 is the curve formed by plotting the values of the deviation degrees obtained by substituting A that is A=1 to N into the deviation function for X that is X=N.

After generating the deviation functions for the layers, the file identifying apparatus 100 calculates the values of the deviation degrees using the deviation functions for the layers for A that is A=1 to N and thereby, obtains the sum of the values of the deviation degrees. A curve 1911 in the graph 1910 is the curve formed by plotting the sums of the deviation degrees for the layers for A that is A=1 to N. For example, from the graph 1910, the degree of risk of file 1 is the absolute value of the difference between the deviation degrees in environments A and B.

A specific example of the embodiment will be described with reference to FIGS. 20 to 27. In the specific example, description will be made up to the process step at which, when an unintended variation of the setting is made to a file in environment A, the name of the file is identified using the file evaluation method according to the embodiment.

FIG. 20 is an explanatory diagram of environments A and B, and the configuration information thereof used in the specific example. The environments A and B used in the specific example each include the servers A to D. The servers in environment A each uses hardware according to configuration information 411A and each have software installed therein. Similarly, the servers in environment B each uses hardware according to configuration information 411B and each have software installed therein. It is assumed that the contents of the configuration information 411A and 411B depicted in FIG. 20 are identical to each other.

The configuration information 411A and 411B indicate that database (DB) server software 1 is installed in each of the servers A and B; DB server software 2 is installed in each of the servers C and D; and web server software is installed in the server D. The configuration information 411A and 411B each include information indicating the inclusion of the servers A to D. Hereinafter, the DB server software will simply be referred to as “DB” and the web server software will simply be referred to as “web”.

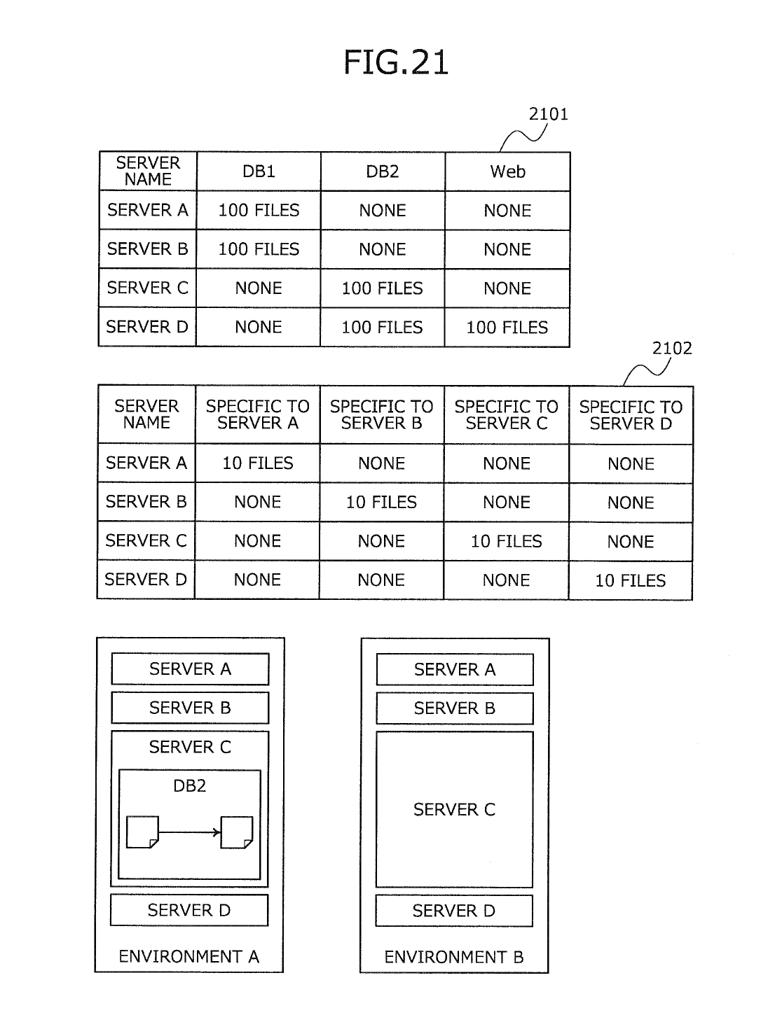

In the example depicted in FIG. 20, the contents of the configuration information 411A and 411B are identical to each other and therefore, the file identifying apparatus 100 determines that the configurations of environments A and B are similar to each other. Description will be made using only the configuration information 411A among the configuration information 411A and 411B with reference to FIG. 21 and the drawings thereafter. Even in a case where the contents of the configuration information 411A and 411B differ from each other, the file identifying apparatus 100 may determine that the configurations of environments A and B are similar to each other when, for example, the difference in the number of servers between the two environments is less than a predetermined threshold value.

FIG. 21 is an explanatory diagram of the files included in environments A and B used in the specific example. Tables 2101 and 2102 indicate the number of files included in environments A and B. Table 2101 indicates the number of files associated with an installation of software. For example, servers A and B each include 100 files associated with the installation of DB1. Servers C and D each include 100 files associated with the installation of DB2. The server D includes 100 files associated with the installation of web.

Table 2102 indicates the number of files specifically included in each server. Server A includes 10 files that are specific thereto. Server B includes 10 files that are specific thereto. Server C includes 10 files that are specific thereto. Server D includes 10 files that are specific thereto.

It is assumed that, after the environments are configured, one file related to the DB2 of server C in environment A is changes due to an unintentional setting change. A case will be described as a comparative case for this embodiment where “diff” is taken among the servers in the environment.

When “diff is taken among the servers in the environment, files that differ between servers A and B in environment A are 20 files based on the table 2102; files that differ between servers A and C in environment A are 220 files based on the tables 2101 and 2102; files that differ between servers A and D in environment A are 320 files based on tables 2101 and 2102; files that differ between servers B and C in environment A are 220 files based on tables 2101 and 2102; files that differ between servers B and D in environment A are 320 files based on the tables 2102 and 2102; and files that differ between servers C and D in environment A are 121 files based on tables 2101 and 2102, and the changed files.

From the above, it turns out that 1,221 files are different as the “diff” comparison result in environment A. However, the 1,221 files are different and therefore, identification of the changed file is difficult.

For environment B, the number of files differing between the servers is equal to that of environment A except for servers C and D and therefore, will not again be described. The files differing between servers C and D in environment B are 120 files, based on tables 2101 and 2102.

From the above, it turns out that 1,220 files are different as the “diff” comparison result in environment B. However, the 1,220 files are different and therefore, identification of the changed file is difficult.

The diff comparison results are compared between the environments as a comparative case for this embodiment. One-hundred twenty-one files are different between servers C and D in environment A, and 120 files are different between servers C and D in environment B. Therefore, though it can be seen that one file is different, it is difficult to identify the one file among the 121 files.

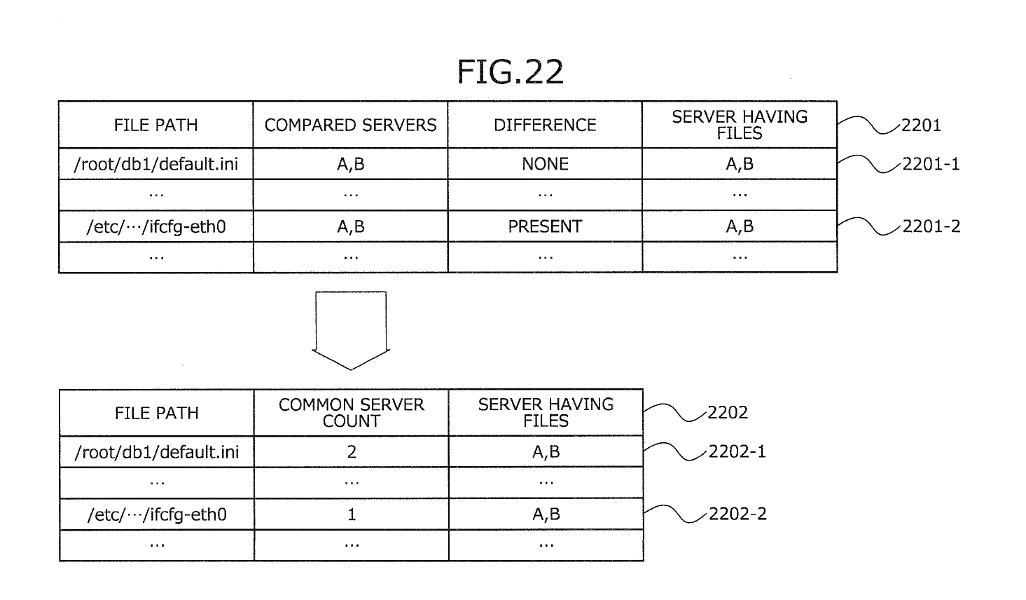

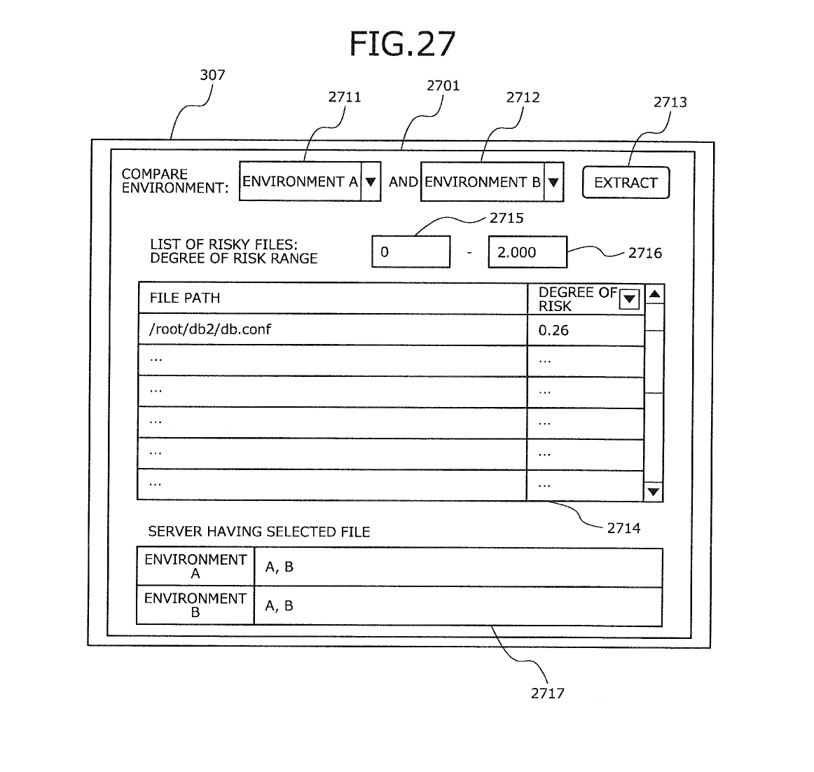

The description will be made with reference to FIGS. 22 to 26 for a procedure up to the process step at which the file evaluation method according to this embodiment is used, and an example presenting the result of the file evaluation method will be described with reference to FIG. 27.

FIG. 22 is an explanatory diagram of a specific example of the generation of the file set table. When an execution request for a file evaluation process is received consequent to user operation, etc., the file identifying apparatus 100, using “diff”, determines for each of the environments, whether any difference is present in an arbitrary combination of the servers. The determination result is indicated in a difference result table 2201. The difference result table 2201 depicted in FIG. 22 includes records 2201-1 and 2201-2.

The difference result table 2201 has four fields for the file path, the compared servers, the difference, and the servers including the files. The “file path” field stores the full path of the file. The “compared servers” field stores identification information concerning the compared two servers. The “difference” field stores the identifier that indicates whether any difference is present between the contents of the files included in the two servers. The “servers including the files” field stores identification information concerning the servers that include the files designated in the file path field.

For example, the record 2201-1 indicates that a file whose file path is “/root/db1/default.ini” is included in both of the servers A and B and no difference is present between the contents included in the servers A and B.

The file identifying apparatus 100 determines whether any difference is present for all the combinations of the servers, and generates a file set table 2202 in one environment. In the example depicted in FIG. 22, a record 2202-1 indicates that the servers having “/root/db1/default.ini” are the servers A and B; and the contents of the two servers are identical to each other, among the servers that each includes the files. A record 2202-2 indicates that the servers having “/etc/ . . . /ifcfg-eth0” are the servers A and B; and the contents of the two servers differ from each other, among the servers that each includes the files.

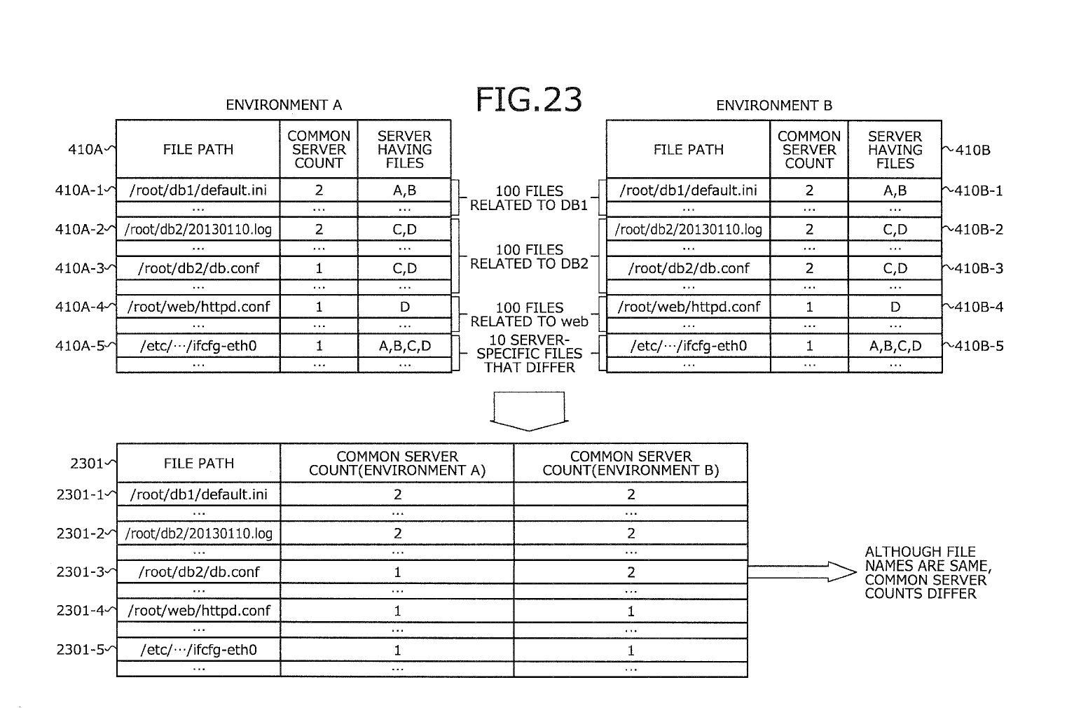

FIG. 23 is an explanatory diagram of a specific example of files whose common server counts differ. The file identifying apparatus 100 generates a set difference table 2301 from the file set tables 410A and 410B for environments A and B.

The file set table 410A for environment A depicted in FIG. 23 includes records 410A-1 to 410A-5. The file set table 410B for environment B depicted in FIG. 23 includes records 410B-1 to 410B-5. The records 410A-1 and 410B-1 are records corresponding to one file among the 100 files related to DB1. The records 410A-2, 410A-3, 410B-2, and 410B-3 are records corresponding to two files among the 100 files related to DB2. The records 410A-4 and 410B-4 are records corresponding to one file among the 100 files related to web. The records 410A-5 and 410B-5 are records corresponding to one file among the server-specific different 10 files.

The set difference table 2301 depicted in FIG. 23 includes records 2301-1 to 2301-5. The set difference table has therein three fields including the one for the file path and the two for the common server count. The “file path” field stores a value equal to that of the file path field of the file set table. The “common server count” fields store the common server counts in two environments of a comparison source environment and a comparison destination environment. A file having different values stored in the two “common server count” fields is a file whose common server counts differ described with reference to FIG. 11.

For example, the record 2301-1 indicates for “/root/db1/default.ini” that the common server count in environment A obtained from the record 410A-1 is two; and the common server count in environment B obtained from the record 410B-1 is two.

In the example of FIG. 23, the file identifying apparatus 100 identifies for the record 2301-1 that the common server count of the files differ between environments A and B, though the files have the same name. At this point, the file identifying apparatus 100 identifies the presence of the difference between the contents of “/root/db2/db.conf” indicated by the record 2301-3; determines “/root/db2/db.conf” as the given file to be evaluated; and determines the degree of risk of the given file, by obtaining the degree of risk thereof. A specific example of the generation of the layers will be described with reference to FIG. 24. An example of calculation of the degree of risk will be described with reference to FIG. 25.

FIG. 24 is an explanatory diagram of the specific example of the generation of the layers. For each of the items such as “hardware” and “software” in the configuration information 411A, the file identifying apparatus 100 counts among the server group N included in the environment, the number of servers related to the item. In the example of FIG. 24, the file identifying apparatus 100 counts two for DB1, two for DB2, and one for web, and generates a configuration information collective table 2401 from the items of the configuration information, the file groups common to all the servers, and the server-specific file groups.

The configuration information collective table 2401 depicted in FIG. 24 includes records 2401-1 to 2401-5, and has therein two fields for the configuration information item and the common server count. The configuration information item stores any one among: the file groups related to each of the items of the configuration information, the file groups common to all the servers, and the server-specific file groups, of the file groups included in the environment. The number of common servers that are correlated with the layer whose contents are deemed not to deviate when the files of the file group identified from the information stored in the configuration information item are classified into the layers is stored, as the common server count. The file identifying apparatus 100 identifies from the configuration information 411A, the layer whose contents of its file group do not deviate when the files of the file group are classified.

For example, the record 2401-1 indicates that the layer whose contents do not deviate when the files of the file group common to all the servers are classified into the layers, is the layer correlated with the common server count that is four indicated by the configuration information 411A. The record 2401-2 indicates that the layer whose contents do not deviate when the files of the file group related to DB1 are classified into the layers is the layer correlated with DB1 that is DB1=2 counted in the configuration information 411A.

The file identifying apparatus 100 generates plural layers from the configuration information collective table 2401. In FIG. 24, the file identifying apparatus 100 generates layers 2411 to 2414 described below.

Layer 2411 is a layer into which a file that is related specifically to the server correlated with a common server count that is one is highly likely to be classified. Layer 2412 is a layer into which a file that is related to DB1 and DB2 correlated with a common server count that is two is highly likely to be classified. Layer 2413 is a layer into which any file that is correlated with a common server count that is three is not likely to be classified. Layer 2414 is a layer into which a file that is common to all the servers correlated with a common server count that is four is classified.

When the file identifying apparatus 100 generates the layers, the file identifying apparatus 100 may generate the layers for the maximum common server count. The file identifying apparatus 100 may generate the layer corresponding to the value stored in the common server count field of the configuration information collective table 2401, and may generate the layer corresponding to all the values not present in the common server count field of the configuration information collective table 2401. It is assumed, for example, that the maximum value of the common server count is 10; and the “common server count” field of the configuration information collective table 2401 has values of one, five, and 10. In this case, the file identifying apparatus 100 generates a layer correlated with a common server count that is one, a layer correlated with a common server counts that are two to four, a layer correlated with a common server count that is five, a layer correlated with a common server counts that are six to nine, and a layer correlated with a common server count that is 10.

FIG. 25 is an explanatory diagram of a specific example of the calculation of the degree of risk. The file identifying apparatus 100 prepares the deviation function for each of the layers by setting the common server count of the layer as X of the deviation function; calculates the value of the deviation degree using the deviation function of the layer for A that is A=1 to N for each configuration information item; obtains the sum of the deviation degrees of the layers; and determines as the degree of risk, the absolute value of the difference of the deviation degree of the layer into which the given file to be compared is classified in the comparison source environment and the deviation degree of the layer into which the given file is classified in the comparison destination environment.

When plural values are present as a common server count correlated with the layer, the file identifying apparatus 100 may prepare the deviation function of the corresponding layer by setting X to be a central value of the values of the common server counts correlated with the layer. As described with reference to FIG. 19, when no item of the configuration information to be classified into layers is present, the file identifying apparatus 100 does not prepare the deviation function for the corresponding layer. Eq. (1) described with reference to FIG. 16 is used as the deviation function used in the example of FIG. 25.

For example, as the process for (1), the file identifying apparatus 100: prepares the deviation function obtained by setting N and X in Eq. (1) to be N=4 and X=4 as the deviation function for layer 2414; substitutes A in the prepared deviation function with each of the values one to four of the common server count correlated respectively with the layers 2411 to 2414; and obtains 0.11, 0.37, 0.78, and zero respectively as the values of the deviation degree.

Similarly, as the process for (2), the file identifying apparatus 100: prepares the deviation function obtained by setting N and X in Eq. (1) to be N=4 and X=2 as the deviation function for layer 2412; substitutes A in the prepared deviation function with each of the values one to four of the common server count correlated respectively with the layers 2411 to 2414; and obtains 0.78, zero, 0.78, and 0.37 respectively as the values of the deviation degree. As the process for (3), the file identifying apparatus 100: substitutes A in the deviation function prepared by setting N and X in Eq. (1) to be N=4 and X=2, with each of the values one to four of the common server count correlated respectively with the layers 2411 to 2414; and obtains 0.78, zero, 0.78, and 0.37 respectively as the values of the deviation degree.

As the process for (4), the file identifying apparatus 100: prepares the deviation function obtained by setting N and X in Eq. (1) to be N=4 and X=1 as the deviation function for layer 2411; substitutes A in the prepared deviation function with each of the values one to four of the common server count correlated respectively with the layers 2411 to 2414; and obtains zero, 0.78, 0.37, and 0.11 respectively as the values of the deviation degree. As the process for (5), the file identifying apparatus 100: substitutes A in the deviation function prepared by setting N and X in Eq. (1) to be N=4 and X=1, with each of the values one to four of the common server count correlated respectively with the layers 2411 to 2414; and obtains zero, 0.78, 0.37, and 0.11 respectively as the values of the deviation degree.

After calculating the values of the deviation degree of the layers, the file identifying apparatus 100 obtains the sum of the values of the deviation degree of the configuration information item for each of the values of the common server count corresponding to the layer. For example, for layer 2411, the file identifying apparatus 100 calculates 0.11+0.78+0.78+0+0=1.67. Similarly, the file identifying apparatus 100 calculates: 0.37+0+0+0.78+0.78=1.93 for layer 2412; 0.78+0.78+0.78+0.37+0.37=3.08 for layer 2413; and 0+0.37+0.37+0.11+0.11=0.96 for layer 2414. In FIG. 25, the sum of the values of the deviation degree for the configuration information items corresponding to the common server count is plotted in a graph 2501.

The files to be compared are classified into layer 2412 in environment A and are classified into layer 2411 in environment B. Therefore, the file identifying apparatus 100 calculates the degree of risk of the file indicated in the record 2301-3 to be 1.93-1.67=0.26.

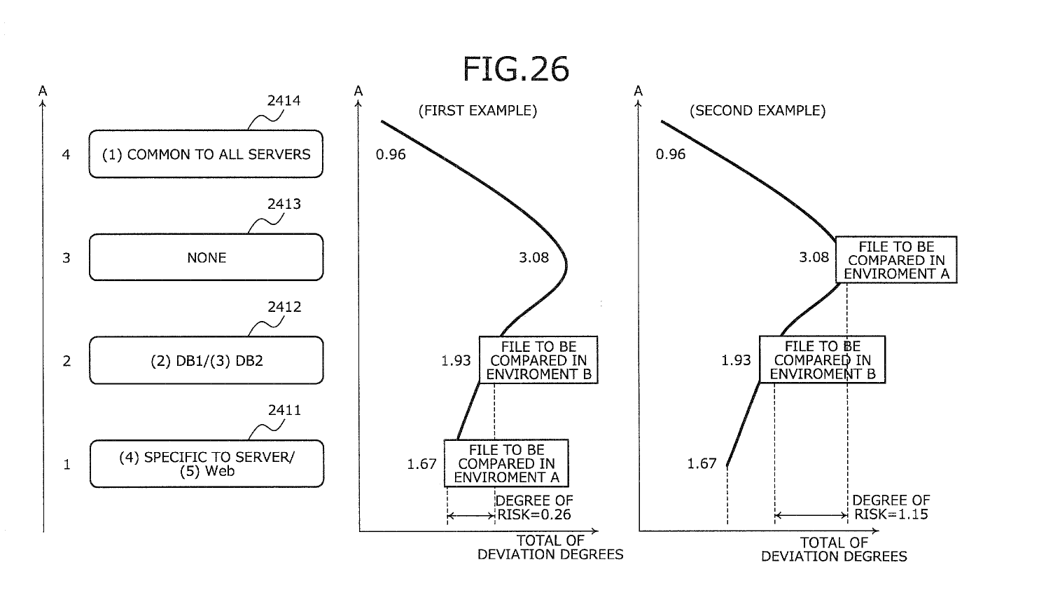

FIG. 26 is an explanatory diagram of the adequacy of the degree of risk. As the adequacy of the degree of risk obtained in FIG. 25, whether the value of the degree of risk is increased for a file whose risk is truly high will be described with reference to FIG. 26. Description will be made with reference to FIG. 26 using the (first example) and the (second example) obtained in FIG. 25. The (first example) is the case where the file identifying apparatus 100 classifies the given file to be evaluated into layer 2411 in environment A and into layer 2412 in environment B. The (second example) is the case where the file identifying apparatus 100 classifies the given file into layer 2413 in environment A and into layer 2412 in environment B.

For a degree of risk that is 0.26 described in the (first example), the given file in environment A is classified into layer 2411 to which “server-specific” and “web” belong. Therefore, the given file in environment A may be a file related to “server-specific” or “web” and therefore, the value of its degree of risk is not great.

For a degree of risk that is 1.15 described in the (second example), the given file in environment A is classified into layer 2413 having no configuration information item present therein. Therefore, the given file in environment A may undergo an unintended setting change and therefore, the value of its degree of risk is great.

FIG. 27 is an explanatory diagram of an example of display of the degree of risk. The file identifying apparatus 100 displays on the display 307, a screen 2701 displaying the degree of risk and thereby, notifies the user of a high risk file. An example of use of the screen 2701 will be described.

The file identifying apparatus 100 designates the comparison source environment and the comparison destination environment using the functions of list boxes 2711 and 2712 by an operation of the mouse 309 by the user. When an extraction button 2713 is pressed down by another operation of the mouse 309 by the user, the file identifying apparatus 100 executes the series of process steps described with reference to FIGS. 22 to 25. After the process steps come to an end, the file identifying apparatus 100 displays the file paths and the degree of risks in descending order of degree of risk in a list 2714. Here, it is assumed that a value is input into a degree of risk lower limit value text box 2715 and a degree of risk upper limit value text box 2716 by operations of the keyboard 308 or the mouse 309 by the user. In this case, the file identifying apparatus 100 displays in the list 2714, the files whose degrees of risk are greater than or equal to the value input in the degree of risk lower limit value text box 2715 and less than or equal to the value input in the degree of risk upper limit value text box 2716, among the files whose degrees of risk are calculated.

When one item is selected from those of the list 2714 by an operation of the mouse 309 by the user, the file identifying apparatus 100 extracts the records corresponding to the file path selected from the file set tables 410A and 410B, and displays in a list 2717, the contents of the server field having the file of the extracted records present therein.

The user checks the contents of the high risk file by referring to the lists 2714 and 2717. In the example of FIG. 27, the user views the contents of “/root/db2/db.conf” included in the servers A and B in environment A to check whether any problem is present.

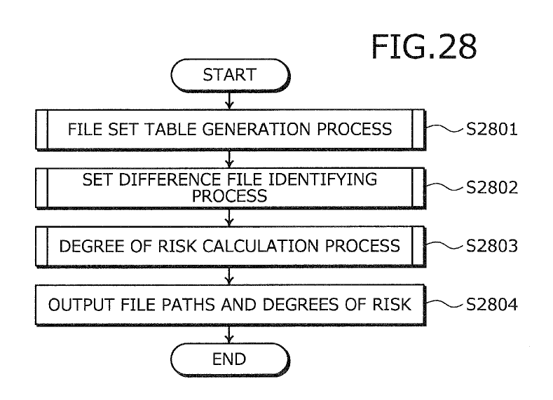

A file evaluation process executed by the file identifying apparatus 100 will be described with reference to FIGS. 28 to 33.

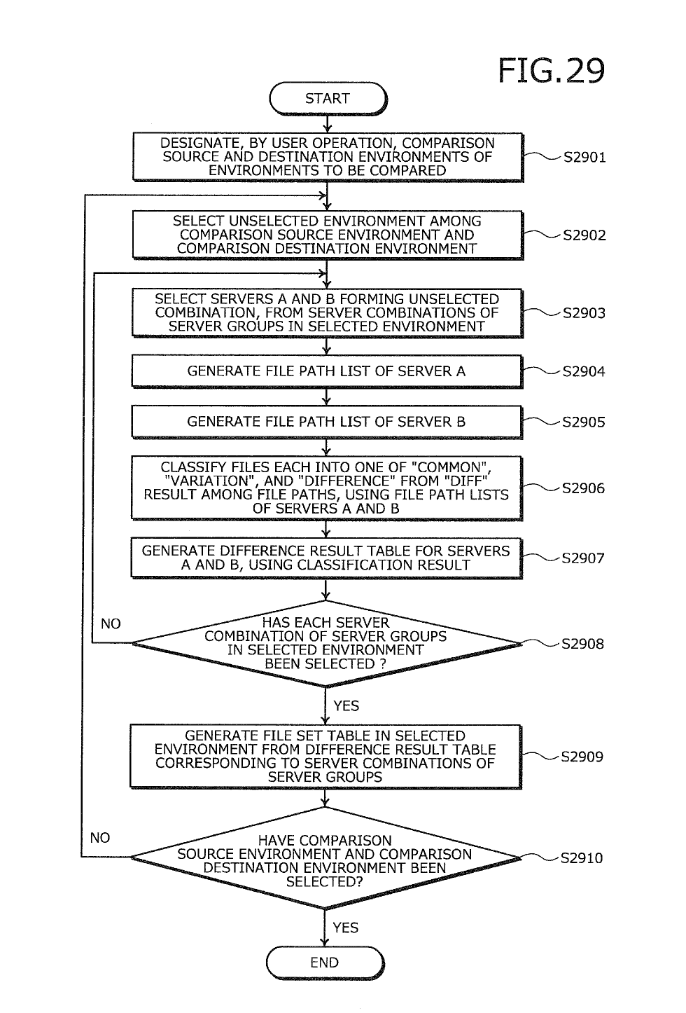

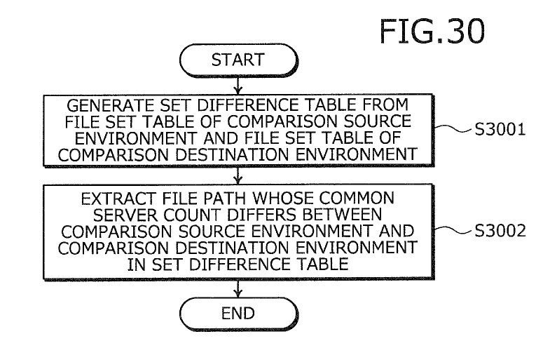

FIG. 28 is a flowchart of an example of a procedure for a file evaluation process. The file evaluation process is a process of calculating the degree of risk to be an evaluation value indicating the degree of the risk for the files. The file identifying apparatus 100 executes a file set table generation process (step S2801). The file set table generation process will be described later with reference to FIG. 29. The file identifying apparatus 100 executes a set difference file identifying process (step S2802). The set difference file identifying process will be described later with reference to FIG. 30. The file identifying apparatus 100 executes a degree of risk calculation process (step S2803) and outputs the file paths and the degrees of risk (step S2804).

After the operation at step S2804 comes to an end, the file identifying apparatus 100 causes the file evaluation process to come to an end. The execution of the file evaluation process enables the file identifying apparatus 100 to notify the user of the high risk files.

FIG. 29 is a flowchart of an example of a procedure for the file set table generation process. The file set table generation process is a process of generating the file set tables of the comparison source environment and the comparison destination environment.

The file identifying apparatus 100 designates the comparison source environment and the comparison destination environment between the environments to be compared, by an operation of the user (step S2901), selects an unselected environment among the comparison source environment and the comparison destination environment (step S2902), and selects the servers A and B forming an unselected combination, from the server combinations of the server groups in the selected environment (step S2903).

The file identifying apparatus 100 generates a file path list of the server A (step S2904), generates a file path list of the server B (step S2905), classifies the files each into any one of “common”, “variation”, and “difference” from the “diff” result among the file paths, using the file path lists of the servers A and B (step S2906), generates a difference result table for the servers A and B, using the classification result (step S2907), and determines whether each of the server combinations of the server groups in the selected environment has been selected (step S2908).

If the file identifying apparatus 100 determines that an unselected server combination is present in the server groups in the environment (step S2908: NO), the file identifying apparatus 100 advances to the operation at step S2903. When the file identifying apparatus 100 determines that all the server combinations are selected in the server groups in the selected environment (step S2908: YES), the file identifying apparatus 100 generates the file set table in the selected environment from the difference result table corresponding to the server combinations of the server groups (step S2909).

The file identifying apparatus 100 determines whether the comparison source environment and the comparison destination environment have been selected (step S2910). If the file identifying apparatus 100 determines that either the comparison source environment or the comparison destination environment has not been selected (step S2910: NO), the file identifying apparatus 100 advances to the operation at step S2902. If the file identifying apparatus 100 determines that the comparison source environment and the comparison destination environment have both been selected (step S2910: YES), the file identifying apparatus 100 causes the file set table generation process to come to an end. The execution of the file set table generation process enables the file identifying apparatus 100 to generate the file set tables of the comparison source environment and the comparison destination environment.

FIG. 30 is a flowchart of an example of a procedure for the set difference file identifying process. The set difference file identifying process is a process of identifying a file whose common server counts are different from each other, by generating the set difference table 2301.

The file identifying apparatus 100 generates the set difference table 2301 from the file set table 410 of the comparison source environment and the file set table 410 of the comparison destination environment (step S3001), extracts a file path whose common server count differs between the comparison source environment and the comparison destination environment in the set difference table 2301 (step S3002), and after the operation at step S3002 comes to an end, causes the set difference file identifying process to come to an end. The execution of the set difference file identifying process enables the file identifying apparatus 100 to identify a file whose common server counts are different from each other.

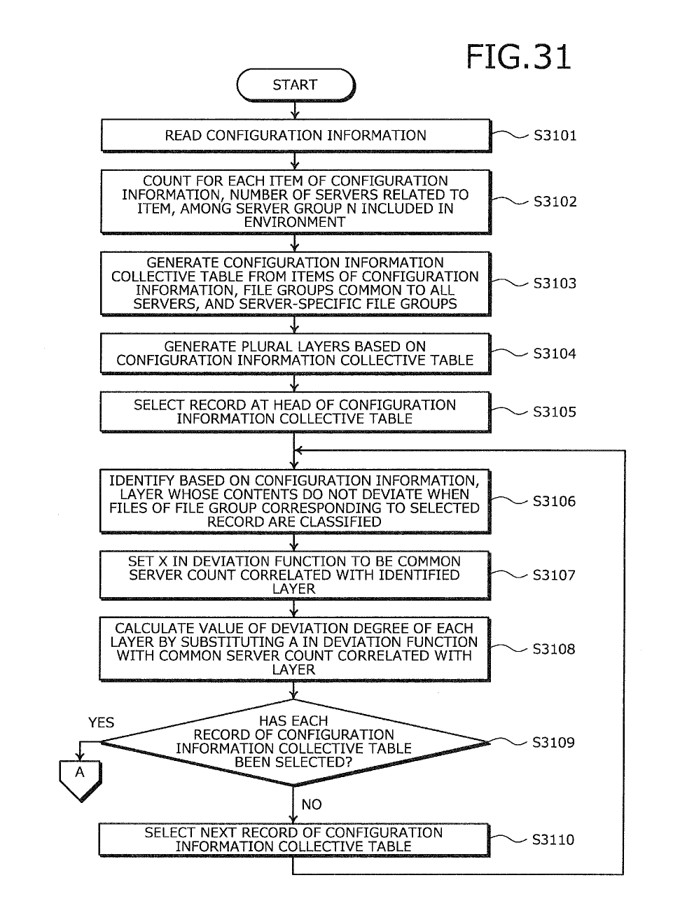

FIGS. 31, 32, and 33 are flowcharts (Parts I, II and III) of an example of a procedure for the degree of risk calculation process. The degree of risk calculation process is a process of calculating the degree of risk for a file whose common server counts are different from each other.

The file identifying apparatus 100 reads the configuration information (step S3101). For example, for the operation at step S3101, the file identifying apparatus 100 reads the configuration information from a simple network management protocol (SNMP) or a configuration management database (CMDB) that manages the configuration information registered using a script to check the configuration management. The script is a script to execute a command on each of the servers in the environment.

The file identifying apparatus 100 counts for each item of the configuration information, the number of servers related to the item, among the server group N included in the environment (step S3102), generates the configuration information collective table 2401 from the items of the configuration information, the file groups common to all the servers, and the server-specific file groups (step S3103), and generates the plural layers based on the configuration information collective table 4201 (step S3104).

The file identifying apparatus 100 selects the record at the head of the configuration information collective table 2401 (step S3105), and identifies based on the configuration information 411, the layer whose contents do not deviate when the files of the file group corresponding to the selected record are classified (step S3106).

The file identifying apparatus 100 sets X in the deviation function to be the common server count correlated with the identified layer (step S3107) and calculates the value of the deviation degree of each of the layers by substituting A in the deviation function with the common server count correlated with the layer (step S3108).

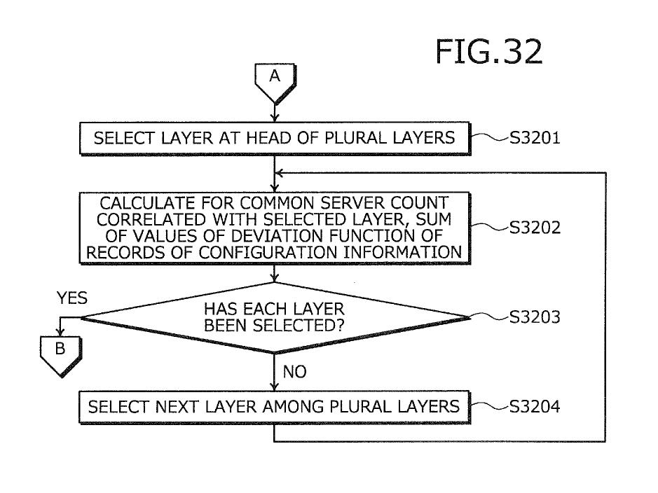

The file identifying apparatus 100 determines whether each of the records of the configuration information collective table 2401 has been selected (step S3109). If the file identifying apparatus 100 determines that an unselected record of the configuration information collective table 2401 is present (step S3109: NO), the file identifying apparatus 100 selects the next record of the configuration information collective table 2401 (step S3110). After the operation at step S3110 comes to an end, the file identifying apparatus 100 advances to the operation at step S3106. If the file identifying apparatus 100 determines that each of the records of the configuration information collective table 2401 has been selected (step S3109: YES), the file identifying apparatus 100 advances to the operation at step S3201 depicted in FIG. 32.

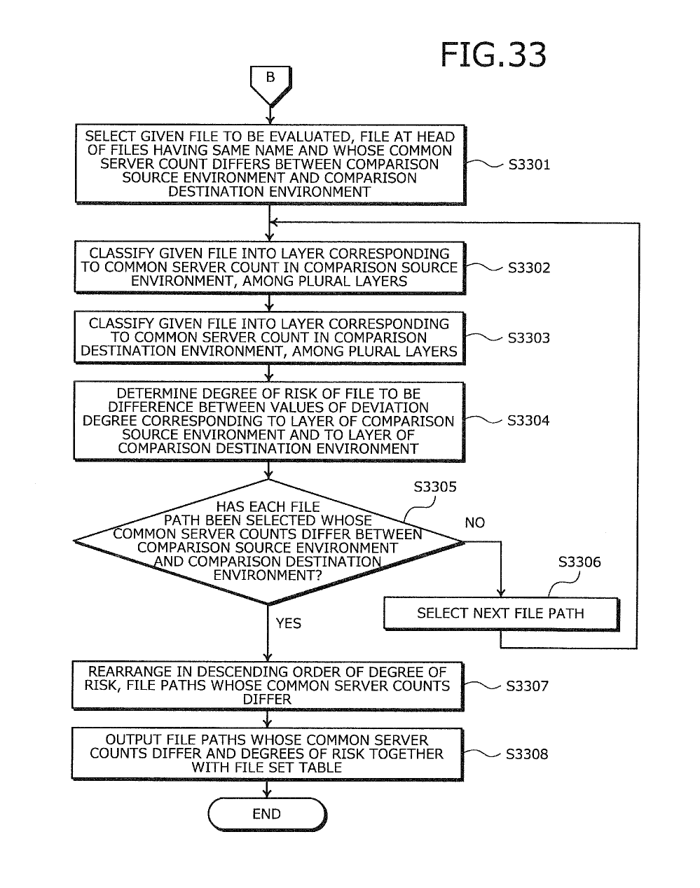

In FIG. 32, for “step S3109: YES”, the file identifying apparatus 100 selects the layer at the head of the plural layers (step S3201), calculates for the common server count correlated with the selected layer, the sum of the values of the deviation function of the records of the configuration information (step S3202), and determines whether each of the layers has been selected (step S3203). If the file identifying apparatus 100 determines that an unselected layer is present (step S3203: NO), the file identifying apparatus 100 selects the next layer among the plural layers (step S3204), and after the operation at step S3204 comes to an end, advances to the operation at step S3202. If the file identifying apparatus 100 determines that each of the layers has been selected (step S3203: YES), the file identifying apparatus 100 advances to the operation at step S3301 depicted in FIG. 33.

In FIG. 33, for “step S3203: YES”, the file identifying apparatus 100 selects as the given file to be evaluated, the file at the head of the files having the same name and whose common server count differs between the comparison source environment and the comparison destination environment (step S3301), classifies the given file into the layer corresponding to the common server count in the comparison source environment, among the plural layers (step S3302), classifies the given file into the layer corresponding to the common server count in the comparison destination environment, among the plural layers (step S3303), and determines the degree of risk of the file to be the difference between the values of deviation degree corresponding to the layer of the comparison source environment and to the layer of the comparison destination environment (step S3304).

The file identifying apparatus 100 determines whether each of the file paths has been selected whose common server counts differ between the comparison source environment and the comparison destination environment (step S3305). If the file identifying apparatus 100 determines that not all the file paths have been selected whose common server counts differ (step S3305: NO), the file identifying apparatus 100 selects the next file path (step S3306) and after the operation at step S3306 comes to an end, advances to the operation at step S3302.

If the file identifying apparatus 100 determines that each of the file paths has been selected whose common server counts differ (step S3305: YES), the file identifying apparatus 100 rearranges in descending order of degree of risk, the file paths whose common server counts differ (step S3307), outputs the file paths whose common server counts differ and the degrees of risk together with the file set table 410 (step S3308), and after the operation at step S3308 comes to an end, causes the degree of risk calculation process to come to an end. The execution of the degree of risk calculation process enables the file identifying apparatus 100 to calculate the degree of risk for a file whose common server counts differ.

At step S3106, the file identifying apparatus 100 may identify the layer for the file group included in the comparison source environment and thereafter, may identify the layer for the file group included in the comparison destination environment. The configurations of the comparison source environment and the comparison destination environment resemble each other and therefore, the identified layer is highly likely to be the same layer for the comparison source environment and the comparison destination environment.

If the identified layer is not the same layer for the comparison source environment and the comparison destination environment, the file identifying apparatus 100 may calculate the degree of risk using the following method. At steps S3107 and S3108, the file identifying apparatus 100 sets X in the deviation function to be the common server count correlated with the layer identified for the comparison source environment and calculates the value of the deviation degree for each layer. Similarly, the file identifying apparatus 100 sets X in the deviation function to be the common server count correlated with the layer identified for the comparison destination environment and calculates the value of the deviation degree for each layer.

At step S3202, for the common server count correlated with the selected layer, the file identifying apparatus 100 calculates the sum of the values of the deviation function in the records of the configuration information in the comparison source environment, and the sum of the values of the deviation function in the records of the configuration information in the comparison destination environment. At step S3304, the file identifying apparatus 100 obtains the “value of the deviation degree corresponding to each layer in the comparison source environment” from the sum of the values of the deviation function in the records of the configuration information in the comparison source environment, and similarly obtains the “value of the deviation degree corresponding to each layer in the comparison destination environment” from the sum of the values of the deviation function in the records of the configuration information in the comparison destination environment.

As described, according to the file identifying apparatus 100, the files having the same path of the file groups included in each of the environments are classified into layers corresponding to the common server count, and files are extracted that have the same name and that are classified in different layers. Thereby, the file whose file content is highly likely to have a problem can precisely be identified and the information concerning this file can be supplied to the user. The possibility for the user to be able to solve the problem is increased by checking the content of the file sequentially, starting with the file for which notification is given.

According to the file identifying apparatus 100, the difference in the deviation degrees corresponding to the layer between the two environments of the files having the same name and classified into different layers is obtained as the degree of risk of the files having the same name.

Thereby, when plural files having the same name and classified into different layers are present, the file identifying apparatus 100 can identify with greater precision, the file whose content is highly likely to have a problem and can supply the information concerning the file to the user. Such a file can be precisely identified because the contents may be normal in the files having the same name and classified into different classes, and files highly likely to have a problem can be identified excluding these files.

According to the file identifying apparatus 100, the plural layers may be generated based on the configuration information 411 and the files of the file groups in environments A and B may each be classified into any one of the plural layers, based on the common server count and the configuration information 411. The configuration information 411 includes information with which the number of servers can be identified.

For example, in a case where the layers are generated of a number equivalent to the number N of servers, in the layer matching the number N of the servers, the contents of the files having the same name do not deviate when the files in the file groups are classified and in the other layers, the contents deviate. In this manner, generation of the layer corresponding to the deviation degree of the contents of the files enables accurate calculation of the degree of risk that is the extent of the possibility that the content of the file has a problem. The layers may be generated to respectively correspond to the number N of servers, the layer for the number N−1 of servers, N−2, . . . . Thereby, the processing amount of the file evaluation process can be suppressed by the amount corresponding to the reduction of the layers, while maintaining the accurate calculation of the degree of risk, which is the extent of the possibility that the content of the file has a problem.

The configuration information 411 may be information identifying the number of servers that each includes the predetermined hardware in the environment, or the number servers that each has the predetermined software installed therein. Among the file groups included in the environment, a file group is highly likely to be present whose common server count matches the number of servers each including the predetermined hardware or the number of servers each having the predetermined software installed therein. Therefore, when the layer is generated whose common server count matches the number of servers each including the predetermined hardware or the number of servers each having the predetermined software installed therein, the layer is generated corresponding to the deviation degree of the contents of the files. The file identifying apparatus 100 can accurately calculate the degree of risk, which is the extent of the possibility that the contents of the file are corrupt.

According to the file identifying apparatus 100, the deviation degree may be calculated using the first deviation function. The first deviation function is the function whose value becomes small when A and X are A=X and when the value of A is significantly different from that of X, and whose value becomes great when the value of A is close to that of X. The use of the first deviation function eliminates the need to store the deviation degree of each layer and therefore, enables the file identifying apparatus 100 to reduce the storage amount.

According to the file identifying apparatus 100, the deviation degree may be calculated using the second deviation function. The second deviation function is the function formed by adding the viewpoint of the number of servers to those of the first deviation function. The use of the second deviation function enables the file identifying apparatus 100 to increase the degree of risk of an item related to many servers, among the items of the configuration information.

The file evaluation method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to an aspect of the embodiments, an effect is achieved that precise identification of a file whose content is corrupt can be facilitated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing a file evaluation program that causes a computer to execute a process comprising:
classifying, for each server group of a plurality of server groups, a plurality of files of a same name into a layer that is one of a plurality of layers, based on a matching degree of contents of the plurality of files, the plurality of files being stored in the server group; and
extracting a first plurality of files having a same name, being classified into different layers, and being stored in different server groups among the plurality of server groups.

2. The non-transitory, computer-readable recording medium according to claim 1, the process further comprising
determining based on the different layers into which the extracted first plurality of files is classified, an evaluation value indicating an extent of a possibility that the contents of the first plurality of files are corrupt, by referring to an index value that indicates a degree of deviation of the contents between the first plurality of files.

3. The non-transitory, computer-readable recording medium according to claim 2, the process further comprising
generating the plurality of layers, based on configuration information that indicates number of servers included in each server group of the plurality of server groups, wherein
the classifying includes classifying for each server group, the plurality of files into a generated layer among the generated plurality of layers, based on the matching degree of the contents and the configuration information of each server group of the plurality of server groups.

4. The non-transitory, computer-readable recording medium according to claim 3, wherein
the configuration information of each server group of the plurality of server groups is information that indicates for each server group, number of servers therein that have predetermined hardware or number of servers in which predetermined software is installed.

5. The non-transitory, computer-readable recording medium according to claim 2, the process further comprising
identifying a layer in which none of the contents of the plurality of files deviate between the plurality files, when the plurality of files is classified, the layer being identified from among the plurality of layers and identified based on configuration information that identifies for each server group, number of servers that include predetermined hardware or number of servers in which predetermined software is installed, wherein
the determining includes determining the evaluation value by calculating a difference of an index value obtained by substituting the identified layer and any one of the different layers into which the extracted first plurality of files are classified, into a function and an index value obtained by substituting into the function, the identified layer and another layer that is different from the any one of the different layers, the function expressing the index value using a layer in which none of the contents of the plurality of files deviate between the plurality of files, when the plurality of files is classified and a layer into which files in any one server in the server group are classified.

6. The non-transitory, computer-readable recording medium according to claim 2, the process further comprising
identifying a layer in which none of the contents of the plurality of files deviate between the plurality of files, when the plurality of files is classified, the layer being identified from among the plurality of layers and identified based on configuration information that identifies for each server group, number of servers that include predetermined hardware or number of servers in which predetermined software is installed, wherein
the determining includes determining the evaluation value by calculating a difference of an index value obtained by substituting number of servers of a server group among the plurality of server groups, the identified layer, and a layer into which the extracted first plurality of files is classified, into a function and an index value obtained by substituting into the function, number of servers of another server group different from the server group and among the plurality of server groups, the identified layer, and a layer into which the extracted first plurality of files is classified, the function expressing the index value using the number of servers identified from configuration information that indicates a configuration of the server group, a layer in which none of the contents of the plurality of files deviate between the plurality of files, when the plurality of files is classified, and a layer into which a file included in any one server in the server group is classified.

7. A file identifying apparatus comprising
a processor configured to:
classify, for each server group of a plurality of server groups, a plurality of files of a same name into a layer that is one of a plurality of layers, based on a matching degree of contents of the plurality of files, the plurality of files being stored in the server group; and
extract a first plurality of files having a same name, being classified into different layers, and being stored in different server groups among the plurality of server groups.

8. A file evaluation method comprising:
classifying, for each server group among a plurality of server groups, a plurality of files of a same name into a layer that is one of a plurality of layers, based on a matching degree of contents of the plurality of files, the plurality of files being stored in the server group; and
extracting a first plurality of files having a same name, being classified into different layers, and being stored in different server groups among the plurality of server groups, wherein
the file evaluation method is executed by a processor.
